(19) United States
(12) Patent Application Publication
(10) Pub. No.: US 2014/0164422 A1
(43) Pub. Date: Jun. 12, 2014

(54) RELATIONAL APPROACH TO SYSTEMS BASED ON A REQUEST AND RESPONSE MODEL

(71) Applicant: VERIZON ARGENTINA SRL, Buenos Aires (AR)

(72) Inventor: Javier Diaz, Buenos Aires (AR)

(73) Assignee: VERIZON ARGENTINA SRL, Buenos Aires (AR)

(21) Appl. No.: 13/708,650

(22) Filed: Dec. 7, 2012

(51) Int. Cl. G06F 17/30

(52) U.S. Cl. CPC G06F 17/30427
USPC 707/760

(57) ABSTRACT

A method, performed by a computer device, may include identifying a query in a query language; converting the identified query into one or more request commands, each of the one or more request commands being in a particular request and response language; and sending the one or more request commands to one or more repliers, wherein the one or more repliers are referenced by the identified query. The method may further include receiving one or more responses from the one or more repliers, each of the one or more responses being in a particular request and response language, and converting the received one or more responses into a relation in the query language, wherein the relation corresponds to an evaluation of the query.

### BACKGROUND INFORMATION

Many types of systems include nodes distributed in an environment, such as a network. One example of such a system is a telecommunication network that includes network elements, such as switches and routers, which guide traffic through the network. In order to manage a network, monitoring of the network elements may need to be performed to determine, for example, whether a particular network element is functioning properly or to determine the amount of traffic through the particular network element. The network may include a large number of devices of different types and may support different communication protocols. The resulting complexity of the system may make network monitoring difficult and challenging. Other types of systems with distributed nodes may suffer from similar problems.

### BRIEF DESCRIPTION OF THE DRAWINGS

FIG. 1A is a diagram illustrating an exemplary unified request and response system according to an implementation described herein;

FIG. 1B is a diagram illustrating an exemplary environment according to an implementation described herein;

FIG. 2 is a diagram illustrating exemplary components of a device that may be included in the environment of FIG. 1;

FIG. 3A is a diagram illustrating exemplary functional components of the restricted distributed relational model management system of FIG. 1;

FIG. 3B is a diagram illustrating exemplary functional components of the unified request and response model management system of FIG. 1;

FIG. 4A is a diagram of exemplary components that may be stored in the unified request and response model instance database of FIG. 3B;

FIG. 4B is a diagram of exemplary components that may be stored in the restricted distributed relational model instance database of FIG. 3A;

FIG. 5 is a flowchart of an exemplary process for configuring information relating to database nodes according to an implementation described herein;

FIG. 6 is a flowchart of an exemplary process for processing a query in a restricted distributed query language according to an implementation described herein;

FIGS. 7A-7C is a flowchart of an exemplary process for evaluating a restricted distributed relational algebra expression according to an implementation described herein;

FIG. 8 is a flowchart of an exemplary process for generating an abstract request based on a restricted distributed relational algebra expression according to an implementation described herein;

FIG. 9 is a flowchart of an exemplary process for generating a relation based on an abstract response according to an implementation described herein;

FIG. 10 is a flowchart of an exemplary process for generating a concrete request based on an abstract request according to an implementation described herein;

FIG. 11 is a flowchart of an exemplary process for generating an abstract response based on a concrete response according to an implementation described herein;

FIGS. 12A-12C are diagrams of a first example that illustrates a relational approach to network monitoring according to an implementation described herein;

FIGS. 13A-13C are diagrams of a second example that illustrates a relational approach to obtaining mobile device information based on location according to an implementation described herein; and

FIGS. 14A-14C are diagrams of a third example that illustrates a relational approach to obtain information from components of a driver information system according to an implementation described herein.

### DETAILED DESCRIPTION OF PREFERRED EMBODIMENTS

The following detailed description refers to the accompanying drawings. The same reference numbers in different drawings identify the same or similar elements.

An implementation described herein relates to extensions to a relational database model. A relational model of a database may describe a database in terms of relation schemas. A relation schema may be defined as a name and a set of attributes. A relation, associated with a relation schema, may be defined as a multi-set of tuples, wherein each tuple includes a value for each attribute of the relation schema. For example, assume the following relation schema: <devices>=(<device_id>, <status>, <type>, <location>, <last_update>). A relation “network_A_devices” associated with the relation schema <devices> may include the following: network_A_devices={|(1, active, router, NY, 01-05-2012), (2, idle, router, NY, 11-12-2011), (3, active, switch, NY, 01-15-2012), (4, active, firewall, LA, 10-21-2011)|}. Relations may be represented as tables. Expressed as a table, the above relation corresponds to:

| DEVICE_ID | STATUS | TYPE | LOCATION | LAST_UPDATE |
|---|---|---|---|---|
| 1 | ACTIVE | ROUTER | NY | Jan. 05, 2012 |
| 2 | IDLE | ROUTER | NY | Nov. 12, 2011 |
| 3 | ACTIVE | SWITCH | NY | Jan. 15, 2012 |
| 4 | ACTIVE | FIRE- | LA | Oct. 21, 2011 |
| | | WALL | | |

In a table representation, each row may represent a tuple of the relation and each column may correspond to an attribute of the relation schema. The value for the attribute in a particular tuple may be included in the column associated with the attribute.

A database schema may be defined as a name and a set of relation schemas. For example, assume a second relation schema <statistics>=(<timestamp>, <device_id>, <stat_name>, <stat_value>). A database schema “network” may be defined as <network>={<devices>, <statistics>}. A database instance, or simply a database, associated with a database schema, may be defined as a set of relations, with each relation being associated with a relation schema in the database schema. For example, assuming a second relation “network_A_statistics,” associated with the relation schema <statistics>, a database “network_A,” associated with the database schema <nework>, may correspond to: network_A={<network_A_devices>, <network_A_statistics>}.

Relations (or tables) in a database may be interpreted as a collection of predicates over a set of predicate variables. The attributes may correspond to the predicate variables. The database may be accessed with a query that corresponds to a particular predicate. As an example, Structured Query Language (SQL) is a language that uses a relational approach to access and manipulate databases. For example, if information about all active devices and their types in New York were desired from relation “network_A_devices,” the following SQL query may be used on the database:

| | |
|---|---|
| SELECT | device_id, type |
| FROM | network_A_devices |
| WHERE | status = ‘active’ |
| AND | location = ‘NY’ |

Processing the above SQL query may return the following relation:

| DEVICE_ID | TYPE |
|---|---|
| 1 | ROUTER |
| 3 | SWITCH |

However, in order to apply a relational approach to a system that includes distributed nodes associated with potentially infinitary relations, extensions to the relational model may need to be made.

An implementation described herein relates to extending a relational model to multiple databases. A relational model that can handle multiple databases may be designated a distributed relational model, because the multiple databases may be treated as a distributed database. For example, in a network of devices, in which each device stores information that may be represented in relations, each device may be designated as a database. A distributed relational model may support multiple, distributed databases, a distributed relational algebra may enable operations to be performed on the distributed relational model, and a distributed relational query language may enable processing of query on multiple databases. The multiple databases that comprise a distributed database may be referred to herein as database nodes of the distributed database.

Furthermore, an implementation described herein relates to extending a relational model to include restricted relation schemas. A restricted relation schema may be defined as a relation schema with a non-empty access key. An access key, associated with a relation schema, may be defined as a subset of attributes of the relation schema for which values must be specified in a query that accesses a relation associated with the relation schema. An access key value may be defined as a tuple that assigns a value to each of the attributes included in the access key. For example, returning to the relation schema <statistics>=(<timestamp>, <device_id>, <stat_name>, <stat_value>), the access key may be defined as (<timestamp>, <device_id>) and an access key value may be the following tuple: (01-01&00-00, 1), which may specify the value “01-01&00-00” for the “timestamp” attribute and the value “1” for the “device_id” attribute. A restricted relation schema may be designated with the access key attributes underlined: <statistics>=(<timestamp>, <device_id>, <stat_name>, <stat_value>). Furthermore, the “unrestriction” of a restricted relation schema may be defined as a relation schema which is identical to the restricted relation schema but with an empty access key. For example, the unrestriction of relation schema <statistics> is <statistics>=(<timestamp>, <device_id>, <stat_name>, <stat_value>).

An access key relation, associated with a restricted relation schema and a specified access key value, may be defined as a relation, associated with the unrestriction of the restricted relation schema, with tuples that match the specified access key value. For example, access key relations for the access key value (01-01 &00-00, 1) may include:

| timestamp | device_id | stat_name | stat_value |
|---|---|---|---|
| 01-01&00-00 | 1 | packets sent | 5480 |
| 01-01&00-00 | 1 | packets received | 5520 |

A restricted relation, associated with a restricted relation schema, may be defined as the additive union of access key relations, one relation for each possible access key value. Thus, a restricted relation may be infinitary, meaning that a restricted relation may include a potentially infinite number of tuples.

For example, if information is stored with a time stamp, the time stamp may include any point in time as a value. If a query is evaluated for a relation that includes tuples based on time stamps, the returned relation may include a potentially infinite number of tuples. Thus, processing such a query may result in impractically long processing times and/or may result in a processor stalling or crashing. Therefore, retrieval of data from a restricted relation may be restricted to a particular access key value. Since a restricted relation is a union of access key relations, retrieval by a query may be restricted to one access key relation (also referred to as a subrelation) at a time. Limiting a particular query to one finite subrelation may guarantee that a query will not attempt to retrieve a potentially infinite amount of data.

A relational model that includes a distributed database and that includes restricted relations may be defined as a restricted distributed relational model (RDRM). Operations on relational models may be performed using relational algebra. In order to ensure that multiple databases may be accessed, and in order to ensure that access to restricted relations is limited to a particular access key value, implementations described herein relate to extensions to a relational algebra. A relational algebra that provides mechanisms for performing operations on an RDRM may be designated as a restricted distributed relational algebra (RDRA).

An implementation described herein further relates to an RDRA that provides mechanisms for performing operations on an RDRM. An RDRA may include extensions to basic expressions in relational algebra. In relational algebra, a basic expression may correspond to the name of a relation schema in a single database. A basic expression R may be evaluated as the relation over R in the single database. In RDRA, a first type of basic expression may take the form of R.N, where R is the name of an unrestricted relation schema and N is the name of a database node, which may represent the relation over R in the database hosted by database node N (referred to herein as a type-1 basic expression). A second type of basic expression in RDRA may take the form σ_{φ}(R.N), where R is the name of a restricted relation schema and N is the name of a database node, where a represents the selection operation of relational algebra, and where φ represents an access key predicate associated with R and an access key value, which may represent the access key relation for the access key value in the relation over R in the database hosted by database node N (referred to herein as a type-2 basic expression). Given an access key value (<value-1>, . . . , <value-n>) for an access key (<attribute-1>, . . . , <attribute-n>), the associated access key predicate may correspond to “<attribute-1>=<value-1> AND . . . AND <attribute-n>=<value-n>.”

In order to enable basic expressions to be correlated to other expressions in RDRA, an access key value may be allowed to assign attributes from another relation schema. An access key value that may assign an attribute from another relation schema may be referred to as a correlated access key value. For example, given relation schemas R1 and R2, with (<attribute_R1-1, <attribute_R1-2>) being the access key of R1, a correlated access key value for R1 with respect to R2 may take the form (<value-1>, <attribute_R2>) and a corresponding correlated access key predicate may take the form (<attribute_R1-1>=<value-1> AND <attribute_R1-2>=<attribute_R2>), where attribute_R2 is an attribute associated with relation schema R2. Thus, a third type of basic expression in RDRA may take the form of σ_{φ}(R.N), where R is the name of restricted relation schema, N is the name of a database node, and φ represents a correlated access key predicate for R with respect to other relation schema S (referred to herein as a type-3 basic expression). Such a type-3 basic expression may be evaluated by substituting all occurrences of attributes of S in φ by their corresponding values for a given S-tuple, which will result in the second type of basic expression (i.e., a selection operation using an access key predicate), and then by evaluating such a type-2 expression.

While particular semantics for basic expressions in RDRA are described herein, definitions of concrete semantics for basic expressions in RDRA may depend on a particular implementation of an RDRM. Thus, a particular implementation of an RDRM may define particular semantics for basic expressions in RDRA that satisfy the specifications described herein.

An RDRA expression may include multiple basic expressions. In order to enable type-3 expressions to be correlated to other expressions in RDRA, an extension to the dependent-join operation of relational algebra may be included in RDRA. A theta-join operation, expressed as R1 [symbol] [symbol] _{θ}R2, may generate a relation that includes all combinations of tuples from R1 and R2 that satisfy the predicate θ. RDRA may include a mechanism for a restricted dependent-join operation.

A restricted dependent-join operator may be used to join a first expression with a second expression using a predicate, in which the second expression includes a selection from a restricted relation schema. A restricted dependent-join operation on a first expression and a second expression, for a predicate, may be defined as a theta-join operation of relational algebra, using the predicate, when the second expression does not include a selection operation on a restricted relation schema, and may be defined as a nested loop join operation using the join predicate ANDed with the predicate of the selection operation, when the second expression does include a selection operation on a restricted relation.

If [symbol] _{θ} represents a restricted dependent-join operation using predicate θ, an expression E₁ [symbol] _{θ}E₂ may be evaluated as follows. If E₂ is an expression of the form σ_{φ}(R.N) such that σ_{(φ and θ)}(R.N) is a type-3 expression, E₁ [symbol] _{θ}E₂ may be evaluated using the following procedure. Starting with result={ }, the expression E₁ may be evaluated to yield relation r₁. For each tuple t in r₁, the expression σ_{(φ and θ)}(R.N) may be evaluated for the tuple t (since the expression is a type-3 expression), and then a Cartesian product may be generated between the singleton relation {|t|} and the evaluated expression and, the resulting relation may be added to the result. Finally, when all tuples in r₁ are processed, the result is returned. Otherwise, if E₂ is not an expression of the aforementioned form, E₁ [symbol] _{θ}E₂ may be evaluated as E₁ [symbol] _{θ}E₂ (i.e., a theta-join operation). When evaluating the type-3 expression, additional semantic validity checks may be performed. For example, RDRA processor 320 may check to make sure that predicate φ only includes attributes of R and that (φ AND θ) is a correlated access key predicate for R and some correlated access key value with respect to the relation schema of r₁.

An implementation described herein may further relate to a query language that may be used to access an RDRM database. Queries in the query language may be evaluated using an RDRA. A query language that may process queries on an RDRM database using RDRA may be referred to as a restricted distributed query language (RDQL). An RDQL may include a syntax in which relation schema names are qualified by database node names. Thus, an implementation described herein relates to a restricted distributed relational model (RDRM), a restricted distributed relational algebra (RDRA) that may be used to manipulate the RDRM, and a restricted distributed query language (RDQL) that may be used to obtain information about the RDRM via RDRA operations on the RDRM.

An implementation described herein further relates to a command-oriented interface for a request and response (R/R) system that may be used to obtain information from an R/R system regardless of the implementation details. An R/R system may include any system that includes a requestor element and one or more repliers. The requestor element may send a request to a replier for execution of a specific command and may receive a response from the replier. The request and the response may be in a particular R/R language. An R/R language may include a set of commands and individual commands may be associated with particular input and output parameters. Thus, a requestor element may send a request to a replier, in a particular R/R language, and may receive a response to the request, in the particular R/R language.

Examples of R/R systems may include a network monitoring system that communicated with network elements using a language such as a Transactional Language 1 (TL1) or Simple Network Management Protocol (SNMP); an automotive sensor system based on a Common Object Request Broker Architecture (CORBA); a network of mobile communication devices using Web Services; an operating system process monitor based on Inter-Process Communication (IPC); and/or any other system in which a requestor element sends a request to a replier for execution of a specific command and receives a response from the replier in response to the request.

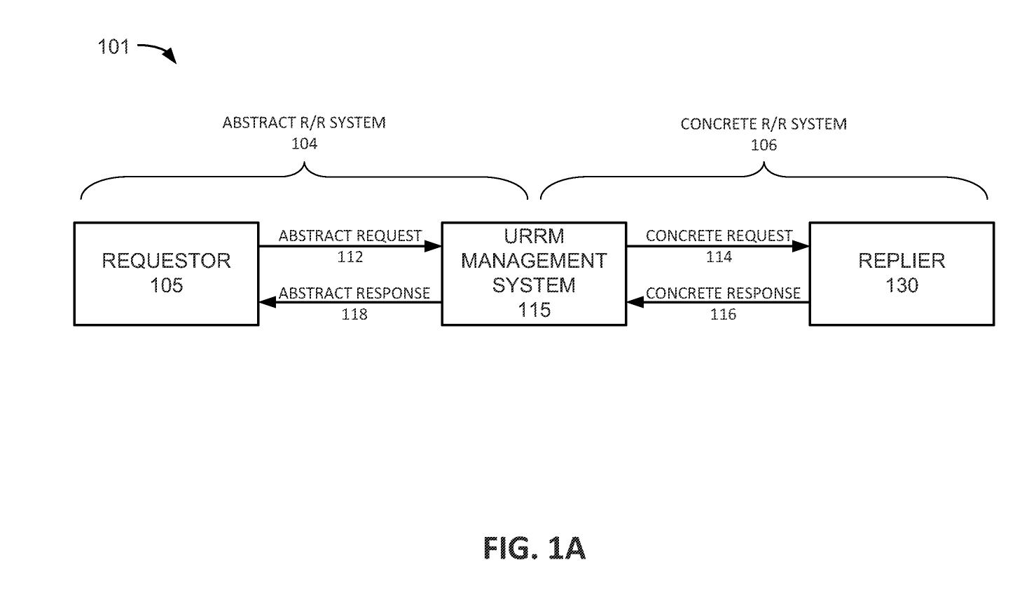

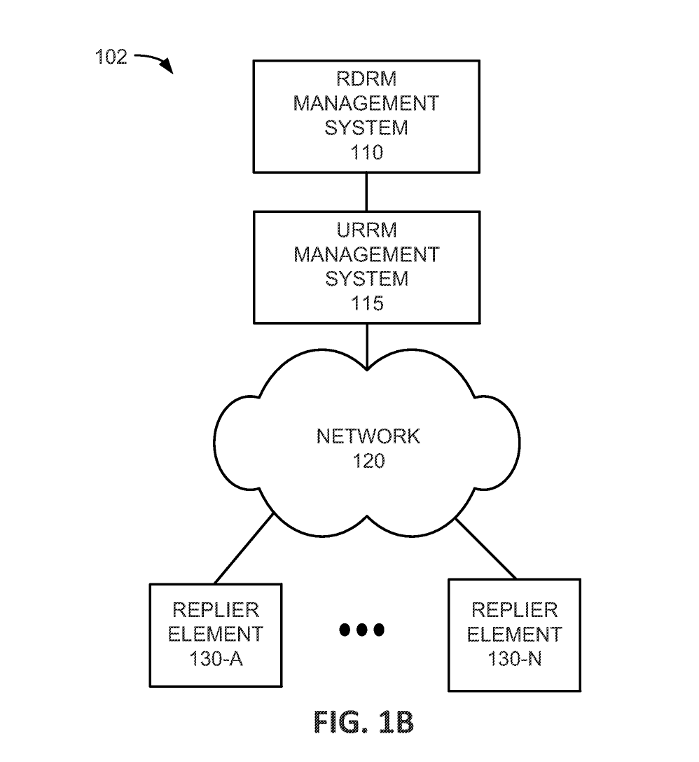

The command-oriented interface described herein may enable a requestor element to interact with repliers regardless of implementation details, and regardless of the R/R language, associated with the repliers. The interface may be implemented using a unified R/R processor that enables a requestor element to obtain information from a replier using a common R/R language, regardless of the particular R/R language used by the replier. The unified R/R processor will be described in the context of a unified R/R model with reference to FIG. 1A.

FIG. 1A shows a unified R/R system 101 according to an implementation described herein. As shown in FIG. 1A, unified R/R system 101 may include a requestor 105, a unified request and response model (URRM) management system 115, and a replier 130 (referred to herein individually as “replier 130” and collectively as “repliers”). While a single replier 130 is shown in FIG. 1A for illustrative purposes, in practice, unified R/R system 101 may include multiple repliers 130.

Unified R/R system 101 may be regarded as including two R/R systems, an abstract R/R system 104, which may include interactions between requestor 105 and URRM management system 115, and a concrete R/R system 106, which may include interactions between URRM management system 115 and replier 130. Thus, with respect to abstract R/R system 104, requestor 105 may act as a requestor element and URRM management system 115 may act as a replier. With respect to concrete R/R system 106, URRM management system 115 may act as a requestor element and replier 130 may act as a replier.

Requestor 105 may send an abstract request 112 to unified R/R language processor 115. Abstract request 112 may be in a common R/R language that requestor 105 and unified R/R language processor 115 use to communicate. The common R/R language may be the only language that requestor 105 needs to use. Abstract request 112 may include information identifying a particular abstract command for replier 130 (e.g., a request for a particular piece of information), may include values for input parameters of the abstract command, and may include information identifying a particular replier 130.

URRM management system 115 may identify the replier associated with abstract request 112, may determine an R/R language associated with the identified replier, and may generate concrete request 114, in the determined R/R language and based on abstract request 112. Replier 130 may receive concrete request 114 and may respond by generating a concrete response 116. Concrete response 116 may include information requested by requestor 105 and may be in the R/R language associated with replier 130.

URRM management system 115 may receive concrete response 116, may determine the R/R language associated with the received concrete response 116, and may parse the response into a collection of records. URRM management system 115 may then generate an abstract response 118 in the common R/R language and may include the generated collection of records in abstract response 118. Requestor 105 may receive abstract response 118 and may retrieve the collection of records from abstract response 118.

Thus, requestor 105 may communicate with repliers 130 through URRM management system 115 and requestor 105 may not need to have information about a particular R/R language associated with replier 130 and may not need to have information about how communication between URRM management system 115 and replier 130 is implemented.

An implementation described herein further relates to enabling a requestor to use a relational approach to obtain information from a replier element. For example, a requestor may process a relational query for information stored in a replier element and may generate a relation that corresponds to the evaluated query. The query may be processed by sending one or more request commands to one or more replier elements to obtain the required information. In order to be able to obtain information from multiple replier elements, the relational approach may use a distributed relational model. Furthermore, a request for a command execution to a replier element may require one or more input parameters. Moreover, information stored in a replier element, such as, for example, spatial and/or temporal information, may be associated with a potentially infinitary relation. In order to ensure that input parameters for a request are provided when a request is generated based on a relational query, and in order to avoid potentially infinitary relations, the relational approach may use a restricted relational model. Still further, in order to use relational queries that are independent of particular R/R languages used by replier elements, a unified R/R language processor may be used to send abstract requests based on a relational query and to provide abstract responses that are to be used to generate a relation that corresponds to the evaluated relational query.

Thus, an implementation described herein relates to evaluating, by a requestor element, an RDQL query into RDRA basic expressions, generating one or more abstract requests based on the RDRA basic expressions, converting the one or more abstract requests into concrete requests by a unified R/R language processor, sending the one or more concrete requests to one or more replier elements, obtaining one or more concrete responses from the one or more replier elements, generating one or more collection of records based on the one or more concrete responses, providing the one or more collections of records to the requestor element in one or more abstract responses, and generating, by the requestor element, a relation that corresponds to the evaluated RDQL query from the one or more abstract responses. Thus, a system (and/or a user) that evaluates the RDQL query may be unaware of the underlying R/R system used to evaluate the query. Rather, the perspective of the system (and/or user) evaluating the query may be that relational database nodes were accessed to evaluate relations of the relation schemas specified in the query.

FIG. 1B is a diagram of an exemplary environment 102 in which the systems and/or methods described herein may be implemented. As shown in FIG. 1, environment 100 may include a RDRM management system 110, URRM management system 115, a network 120, and one or more repliers 130-A to 130-N (referred to herein collectively as “repliers 130” and individually as “replier 130”).

The components of environment 102 may function as a unified R/R system 101 with RDRM management system 110 functioning as requestor 105. RDRM management system 110 may include one or more devices, such as server devices, that process RDQL queries. RDRM management system 110 may identify an RDQL query, may identify one or more repliers 130 referenced by the RDQL query, may decompose the RDQL query into one or more RDRA basic expressions, may generate one or more abstract requests based on the one or more RDRA basic expression, may send the generated one or more abstract requests to URRM management system 115, and may receive one or more abstract responses from URRM management system 115. RDRM management system 110 may generate a relation that corresponds to the evaluated RDQL query from the received one or more abstract responses.

URRM management system 115 may function as described above with reference to FIG. 1A, with RDRM management system 110 acting as requestor 105. In some implementations, URRM management system 115 may be part of RDRM management system 110. In other implementations, environment 102 may not include URRM management system 115 and RDRM management system 110 may communicate with repliers 130 as a single R/R system, rather than as a unified R/R system.

Network 120 may include any network that may enable RDRM management system 110 to communicate with repliers 130. Network 120 may include a packet-switched network, a circuit-switched network, or a combination thereof. For example, network 130 may include a local area network (LAN), a wide area network (WAN), a metropolitan area network (MAN), an ad hoc network, an intranet, a fiber optic-based network (e.g., a fiber optic service network), a wireless network (e.g., a cellular network, the Public Land Mobile Network (PLMN), a second generation (2G) network, a third generation (3G) network, a fourth generation (4G) network (e.g., a long term evolution (LTE) network), a fifth generation (5G) network, a code division multiple access (CDMA) network, a global system for mobile communications (GSM) network, a general packet radio services (GPRS) network, a combination of thereof), and/or a combination of these or other types of networks.

Replier 130 may include any device with a communication function and may be able to communicate with URRM management system 115, and/or with RDRM management system 110, using an R/R language. For example, replier 130 may include a personal computer or workstation; a server device; a portable computer, a printer, fax machine, or another type of physical medium output device; a television, a projector, a speaker, or another type of a display or audio output device; a set-top box; a gaming system; a camera, a video camera, a microphone, a sensor, or another type of input or content recording device; a portable communication device (e.g. a mobile phone, a smart phone, a tablet computer, a global positioning system (GPS) device, and/or another type of wireless device); a voice over Internet Protocol (VoIP) telephone device; a radiotelephone; a gateway, a router, a switch, a firewall, a network interface card (NIC), a hub, a bridge, a proxy server, or another type of network device; an optical transceiver or a line terminating device, such as an add-drop multiplexer or an optical network terminal; a cable modem; a cable modem termination system; and/or any type of device with communication capability.

Although FIG. 1 shows exemplary components of environment 102, in other implementations, environment 102 may include fewer components, different components, differently arranged components, or additional components than depicted in FIG. 1. Additionally or alternatively, one or more components of environment 102 may perform functions described as being performed by one or more other components of environment 102.

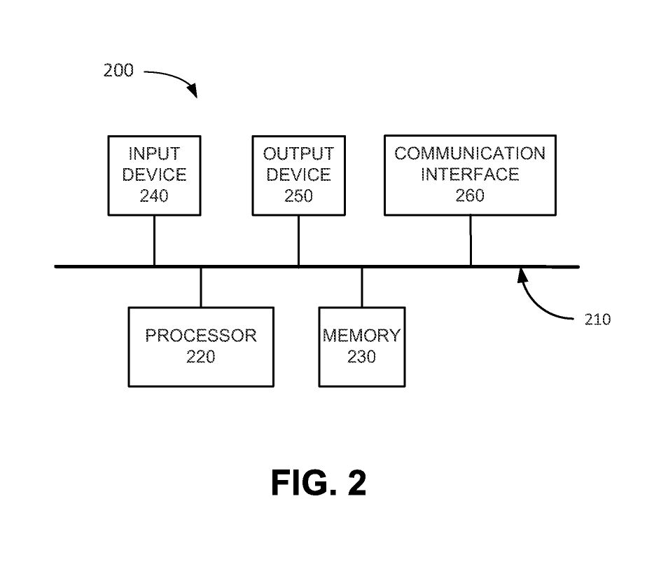

FIG. 2 is a diagram illustrating exemplary components of a device 200 according to an implementation described herein. RDRM management system 110, URRM management system 115, and/or replier 130 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying information. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to radio frequency (RF) signals and/or a receiver that converts RF signals to baseband signals. Communication interface 260 may be coupled to an antenna for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations using a relational approach to obtain information from a system of elements that use an R/R language. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally or alternatively, one or more components of device 200 may perform one or more tasks described as being performed by one or more other components of device 200.

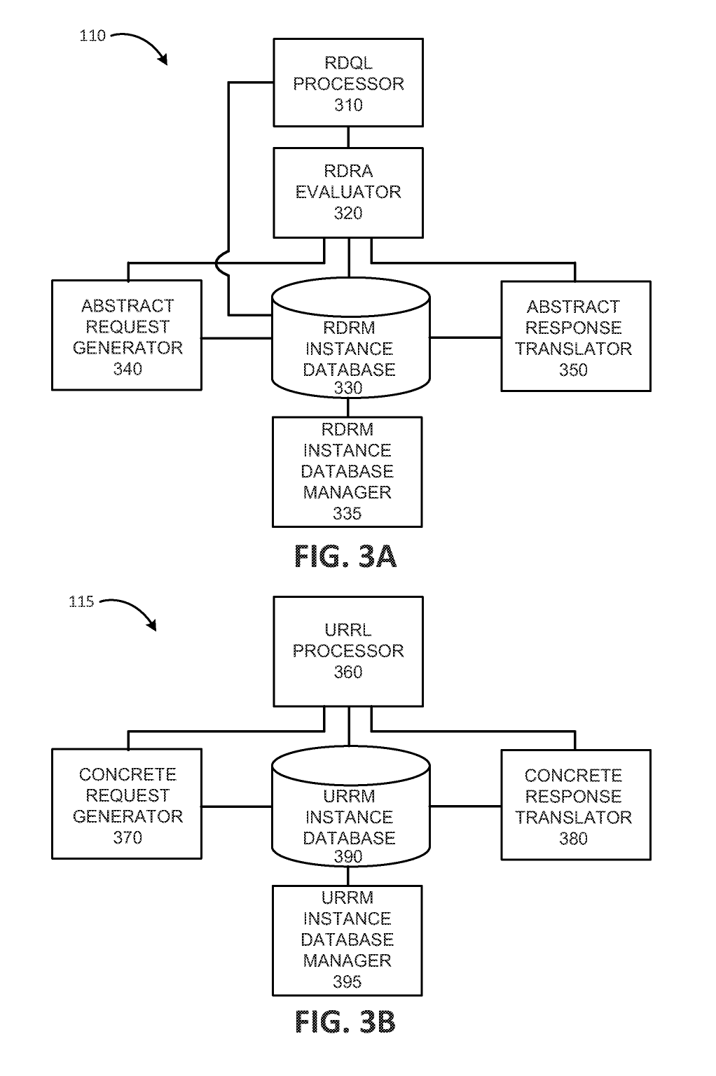

FIG. 3A is a diagram illustrating exemplary functional components of RDRM management system 110. The functional components of RDRM management system 110 may be implemented, for example, via processor 220 executing instructions from memory 230. Alternatively, some or all of the functional components of RDRM management system 110 may be hardwired. As shown in FIG. 3A, RDRM management system 110 may include an RDQL processor 310, an RDRA evaluator 320, a database (DB) node database 330, a RDRM instance database manager 335, an abstract request generator 340, and an abstract response translator 350.

RDQL processor 310 may process an RDQL query. As an example, RDQL processor 310 may receive a request to process a particular RDQL query from another computing device. As another example, RDQL processor 310 may monitor instructions and/or code, associated with a particular process or a particular computing device, for an RDQL query and may process a detected RDQL query. RDQL processor 310 may check an RDQL query for syntactic validity and may check the RDQL query for semantic validity. RDQL processor 310 may translate an RDQL query into a corresponding RDRA expression.

RDRA evaluator 320 may determine RDRA basic expressions associated with an RDRA expression corresponding to an RDQL query. Furthermore, RDRA evaluator 320 may access RDRM instance database 330 and determine whether access key requirements are satisfied for a relation schema associated with a DB node referenced by the RDQL query. RDRA evaluator 320 may provide RDRA basic expressions to abstract request generator 340, may receive one or more relations from abstract response translator 350 as corresponding to evaluated RDRA basic expressions, and may combine the received one or more relations into a relation corresponding to an evaluated RDQL query, using RDRA (e.g., by performing relational operations such as selection operations, projection operations, restricted dependent join operations, etc.).

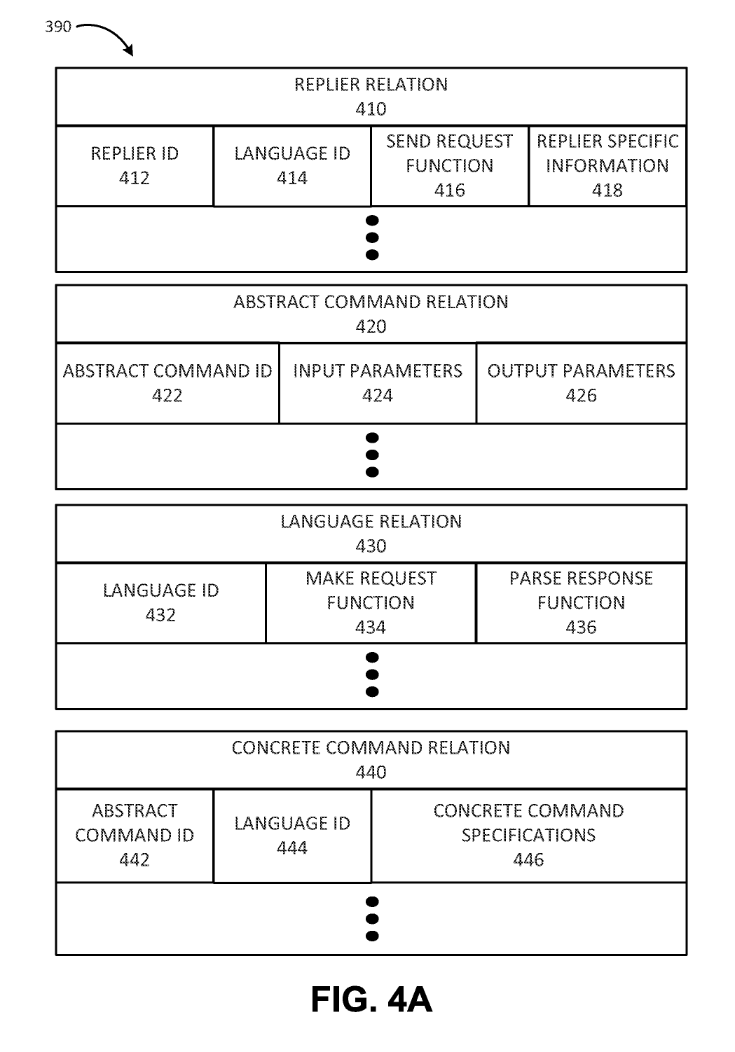

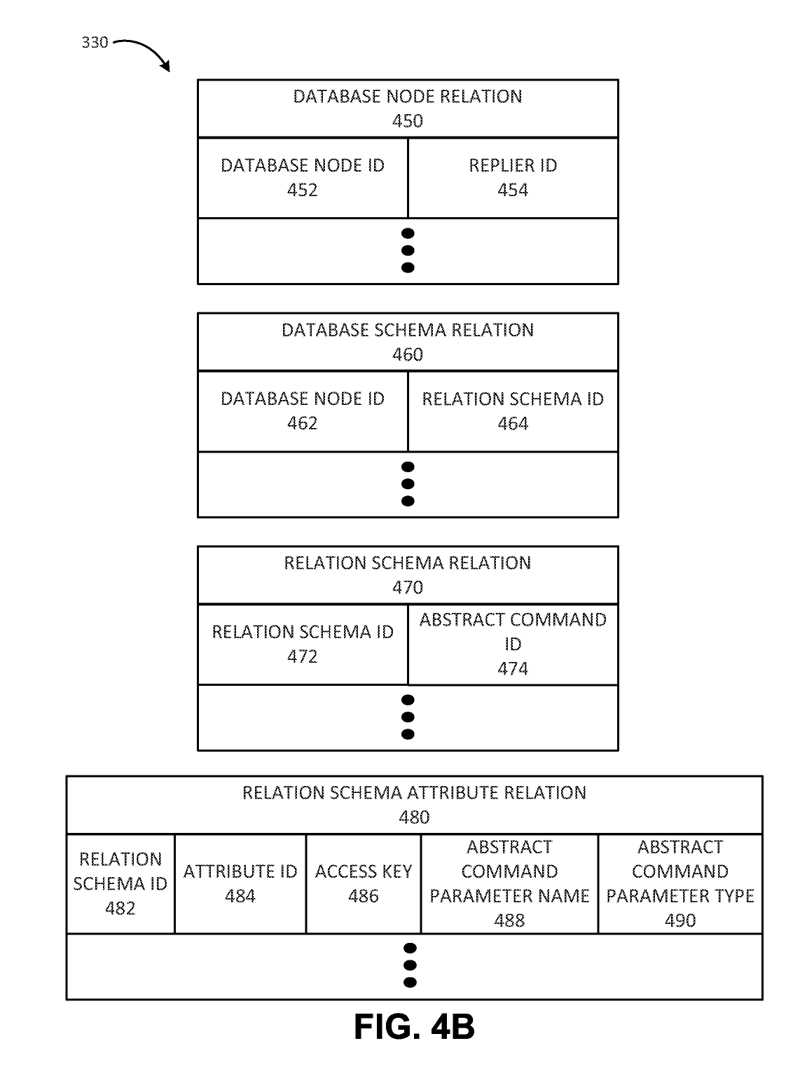

RDRM instance database 330 may store information associated with particular DB nodes. Exemplary information that may be stored in RDRM instance database 330 is described below with reference to FIG. 4B. RDRM instance database manager 335 may generate RDRM instance database 330 based on information about repliers obtained from unifier R/R language processor 115. Furthermore, RDRM instance database manager 335 may update information in RDRM instance database 330 based on update information received from URRM management system 115. For example, if a new replier 130 is added to environment 102, URRM management system 115 may obtain information about the new replier 130 and may send the information to RDRM instance database manager 335, which may update RDRM instance database 330 based on the received information.

Abstract request generator 340 may generate an abstract request command based on an RDRA basic expression received from RDRA processor. For example, abstract request generator 340 may determine a replier 130 associated with a DB node referenced by an RDRA basic expression, may determine an abstract command associated with the relation schema referenced by the RDRA basic expression, and may construct an input parameter list for the abstract command from the RDRA basic expression. Abstract request generator 340 may send the generated abstract request to URRM management system 115.

Abstract response translator 350 may receive an abstract response that includes a collection of records from URRM management system 115 and may generate a relation from the collection of records using information included in RDRM instance database 330. For example, abstract response translator 350 may obtain the constructed input parameter list associated with the abstract request corresponding to the received abstract response, may obtain a collection of records from the abstract response, may derive a tuple from each record and the obtained input parameter list, and may add the derived tuple to the generated relation. Abstract response translator 350 may provide the generated relation to RDRA evaluator 320. As stated above, RDRA evaluator 320 may combine received relations, corresponding to evaluated RDRA basic expressions, into a relation corresponding to an evaluated RDQL query, using RDRA.

Although FIG. 3A shows exemplary functional components of RDRM management system 110, in other implementations, RDRM management system 110 may include fewer functional components, different functional components, differently arranged functional components, or additional functional components than those depicted in FIG. 3A. Additionally or alternatively, one or more functional components of RDRM management system 110 may perform functions described as being performed by one or more other functional components of RDRM management system 110.

FIG. 3B is a diagram illustrating exemplary functional components of URRM management system 115. The functional components of URRM management system 115 may be implemented, for example, via processor 220 executing instructions from memory 230. Alternatively, some or all of the functional components of URRM management system 115 may be hardwired. As shown in FIG. 3B, URRM management system 115 may include a unified request and response language (URRL) processor 360, a concrete request generator 370, a concrete response translator 380, a URRM instance database 390, and a URRM instance database manager 395.

URRL processor 360 may obtain an abstract request from RDRM management system 110, may call concrete request generator 370 to generate a concrete request based on the abstract request, and may forward the generated concrete request to replier 130. URRL processor 360 may further receive a concrete response from replier 130, may call concrete response translator 380 to translate the concrete response into an abstract response, and may forward the abstract response to RDRM management system 110.

Concrete request generator 370 may receive an abstract request from URRL processor 360 and may generate a concrete request based on the abstract request. For example, concrete request generator 370 may determine a replier 130 associated with an abstract request and may determine an R/R language associated with replier 130, based on information stored in URRM instance database 390. Concrete request generator 370 may generate a concrete request for replier 130 in the determined R/R language, using a function associated with the determined R/R language and based on input parameters included in the abstract command.

Concrete response translator 380 may receive a concrete response from replier 130 and may generate an abstract response based on the received concrete response. For example, concrete response translator 380 may identify a replier 130 associated with a received concrete response, may determine an R/R language associated with the identified replier 130, and may parse the concrete response into a collection of records using a parse function associated with the determined R/R language, based on information stored in URRM instance database 390. The collection of records may be used to generate an abstract response that may be sent to RDRM management system 110 by URRL processor 360.

URRM instance database 390 may store information relating to repliers 130. Exemplary information that may be stored in URRM instance database 390 is described below with reference to FIG. 4A. URRM instance database manager 395 may generate URRM instance database 390 and may manage information in URRM instance database 390. As example, URRM instance database manager 395 may obtain information about replier 130 by, for example, querying replier 130 for particular types of information. As another example, URRM instance database manager 395 may access a database of repliers (e.g., an existing inventory of repliers), may retrieve information from the database of repliers, and may populate URRM instance database 390 based on the retrieved information. As yet another example, URRM instance database manager 395 may obtain information about replier 130 based on input entered by an administrator of replier 130. URRM instance database manager 395 may also send information about updates to URRM instance database 390 to RDRM management system 110 and RDRM management system 110 may update RDRM instance database 330 based the received updates.

Although FIG. 3B shows exemplary functional components of URRM management system 115, in other implementations, URRM management system 115 may include fewer functional components, different functional components, differently arranged functional components, or additional functional components than those depicted in FIG. 3B. Additionally or alternatively, one or more functional components of URRM management system 115 may perform functions described as being performed by one or more other functional components of URRM management system 115.

FIG. 4A is a diagram of exemplary components that may be stored in URRM instance database 390. As shown in FIG. 4A, URRM instance database 390 may include a replier relation 410, an abstract command relation 420, a language relation 430, and a concrete command relation 440.

Replier relation 410 may store information about repliers 130-A to 130-N. Replier relation 410 may include a replier identifier (ID) attribute 412, a language ID attribute 414, a send request function attribute 416, and a replier specific information attribute 418. Replier ID attribute 412 may store information about an identifier associated with a particular replier 130. Language ID attribute 414 may store information about the R/R language associated with the particular replier 130. Send request function attribute 416 may store a function used to send a concrete request to the particular replier 130 and to receive a concrete response back from the particular replier 130. Replier specific information attribute 418 may store other information associated with the particular replier 130, such as a network address (e.g., an Internet Protocol (IP) address), a terminal identifier, a group identifier associated with a group of which the particular replier 130 is a member, and/or any other information that may be associated with the particular replier 130.

Abstract command relation 420 may store information relating to manipulation of abstract commands. For example, abstract command relation 420 may store information that specifies a unified R/R language used to communicate between RDRM management system 110 and unifier R/R language processor 115. Abstract command relation 420 may include an abstract command ID attribute 422, an input parameters attribute 424, and an output parameters attribute 426. Abstract command ID attribute 422 may store an identifier associated with a particular abstract command. Input parameters attribute 424 may store information about the input parameters associated with the particular abstract command. The input parameters may be in a format independent of any particular R/R language. Output parameters attribute 426 may store information about the output parameters associated with the particular abstract command. The output parameters may be in a format independent of any particular R/R language.

Language relation 430 may store information about a particular R/R language used by one or more repliers 130 in environment 102. Language relation 430 may include a language ID attribute 432, a make request function attribute 434, and a parse response function attribute 436. Language ID attribute 432 may store information identifying a particular R/R language used by one or more repliers 130 (e.g., TL1 language, SNMP, IDL operation specifications for CORBA, WSDL operation specifications for Web Services, etc.). Make request function attribute 434 may store a function that generates a concrete request command based on an abstract command ID and based on values associated with the input parameters of the abstract command associated with the abstract command ID. Parse response function attribute 436 may store a function that generates a collection of records from a concrete response. The collection of records may be used to generate an abstract response.

Concrete command relation 440 may store information relating to a concrete command in a particular R/R language. Concrete command relation 440 may include an abstract command ID attribute 442, a language ID attribute 444, and a concrete command specifications attribute 446. Abstract command ID attribute 442 may store information identifying the abstract command associated with the concrete command in the particular R/R language. Language ID attribute 444 may store information identifying the particular R/R language. Concrete command specifications attribute 446 may store specifications associated with the concrete command. For example, concrete command specifications attribute 446 may store TL1 command syntax specifications for a TL1 language, may store Management Information Base (MIB) for SNMP, interface definition language (IDL) operation specifications for CORBA, Web Services Description Language (WSDL) operation specifications for Web Services, and/or specifications for another R/R language.

Although FIG. 4A shows exemplary components of URRM instance database 390, in other implementations, URRM instance database 390 may include fewer relations and/or relation attributes, different relations and/or relation attributes, differently arranged relations and/or relation attributes, or additional relations and/or relation attributes than those depicted in FIG. 4A.

FIG. 4B is a diagram of exemplary components that may be stored in RDRM instance database 330. As shown in FIG. 4B, RDRM instance database 330 may include a DB node relation 450, a DB schema relation 460, a relation schema relation 470, and a relation schema attribute relation 480.

DB node relation 450 may include information associating particular DB nodes with particular repliers 130. DB node relation 450 may include a DB node ID attribute 452 and a replier ID attribute 454. DB node ID attribute 452 may include information identifying a particular DB node. Replier ID attribute 454 may store information identifying a particular replier 130 associated with the particular DB node.

Database schema relation 460 may include information associating particular DB nodes with particular relation schemas. DB node relation 450 may include a DB node ID attribute 462 and a relation schema ID attribute 464. DB node ID attribute 452 may include information identifying a particular DB node. Relation schema ID attribute 464 may store information identifying a particular relation schema associated with the particular DB node.

Relation schema relation 470 may include information associating particular relation schemas with particular abstract commands. Relation schema relation 470 may include a relation schema ID attribute 472 and an abstract command ID attribute 474. Relation schema ID attribute 472 may store information identifying a particular relation schema. Abstract command ID attribute 474 may identify a particular abstract command associated with the particular relation schema.

Relation schema attribute relation 480 may store information relating to particular attributes of a relation schema. Relation schema attribute relation 480 may include a relation schema ID attribute 482, an attribute ID attribute 484, an access key attribute 486, an abstract command parameter name attribute 488, and an abstract command parameter type attribute 490. Relation schema ID attribute 482 may identify a particular relation schema. Attribute ID attribute 484 may identify a particular attribute of the particular relation schema. Access key attribute 486 may store an indication as to whether the particular attribute is included in the access key associated with the particular relation schema. Abstract command parameter name attribute 488 may identify an abstract command parameter associated with the particular attribute. Abstract command parameter type attribute 490 may identify whether the abstract command parameter corresponds to an input parameter or an output parameter.

Although FIG. 4B shows exemplary components of DB node database 350, in other implementations, DB node database 350 may include fewer relations and/or relation attributes, different relations and/or relation attributes, differently arranged relations and/or relation attributes, or additional relations and/or relation attributes than depicted in FIG. 4B.

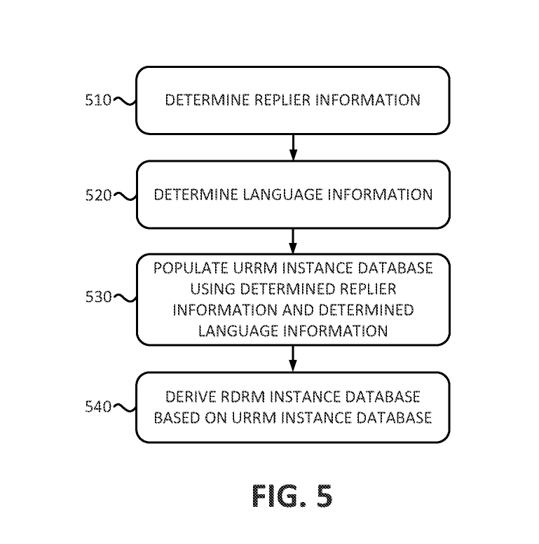

FIG. 5 is a flowchart of an exemplary process for configuring information relating to database nodes according to an implementation described herein. In one implementation, the process of FIG. 5 may be performed by RDRM management system 110 and/or URRM management system 115. In other implementations, some or all of the process of FIG. 5 may be performed by another device or a group of devices separate from RDRM management system 110 and/or URRM management system 115, and/or including RDRM management system 110 and/or URRM management system 115.

The process of FIG. 5 may include determining replier information (block 510). For example, URRM instance database manager 395 may obtain information about a particular replier 130. In some implementations, URRM instance database manager 395 may query the particular replier 130 for information, such as an R/R language associated with the particular replier 130. For example, URRM instance database manager 395 may attempt to query the particular replier 130 using different R/R languages and may determine which R/R language resulted in receiving a successful response from the particular replier 130. In other implementations, URRM instance database manager 395 may obtain information about the particular replier 130 by accessing an existing database of repliers 130, such as, for example, an inventory of devices in a network. In yet other implementations, URRM instance database manager 395 may obtain information relating to the particular replier 130 by receiving input from an administrator associated with the particular replier 130.

Language information may be determined (block 520). For example, URRM instance database manager 395 may obtain information about a particular R/R language, such as syntax associated with particular commands and/or responses, input and/or output parameters associated with particular commands and/or responses, and/or any other specifications associated with the particular R/R language. In some implementations, the R/R language information may be obtained from specification documents associated with the particular R/R language. For example, URRM instance database manager 395 may identify a specification document associated with the particular R/R language and may parse out information relating syntax of commands associated with the particular R/R language from the specification document. In other implementations, URRM instance database manager 395 may obtain information relating to a particular R/R language by receiving input from an administrator.

A URRM instance database may be populated using the determined replier information and the determined language information (block 530). For example, URRM instance database manager 395 may generate replier relation 410 based on the obtained information relating to repliers 130 and may generate language relation 430 based on the obtained information relating to particular R/R languages. URRM instance database manager 395 may then generate abstract command relation 420, which may specify input and output parameters for an abstract command. URRM instance database manager 395 may then generate concrete command relation 440 based on information relating to commands associated with particular R/R languages and may associate a particular abstract command in abstract command relation 420 with a particular concrete command.

An RDRM instance database may be derived based on the URRM instance database (block 540). For example, URRM instance database manager 395 may provide information from URRM instance database 390 to RDRM instance database manager 335 of RDRM management system 110. RDRM instance database manager 335 may derive DB node relation 450, database schema relation 460, relation schema relation 470, and/or relation schema attribute relation 480 based on the received information. In some implementations, RDRM instance database manager 335 may derive DB node IDs based on replier IDs. In other implementations, RDRM instance database manager 335 may correlate replier IDs with an existing set of database node IDs. Furthermore, RDRM instance database manager 335 may derive attribute IDs associated with a relation schema based on a list of input and/or output parameters associated with an abstract command that may be associated with a particular replier 130. In some implementations, RDRM instance database manager 335 may derive relation schema IDs based on abstract command IDs. In other implementations, RDRM instance database manager 335 may correlate relation schema IDs with an existing set of relation schema IDs. Furthermore, RDRM instance database manager 335 may derive an access key for a relation schema. The access key may be derived, for example, based on input parameters associated with the abstract commands associated with a relation schema.

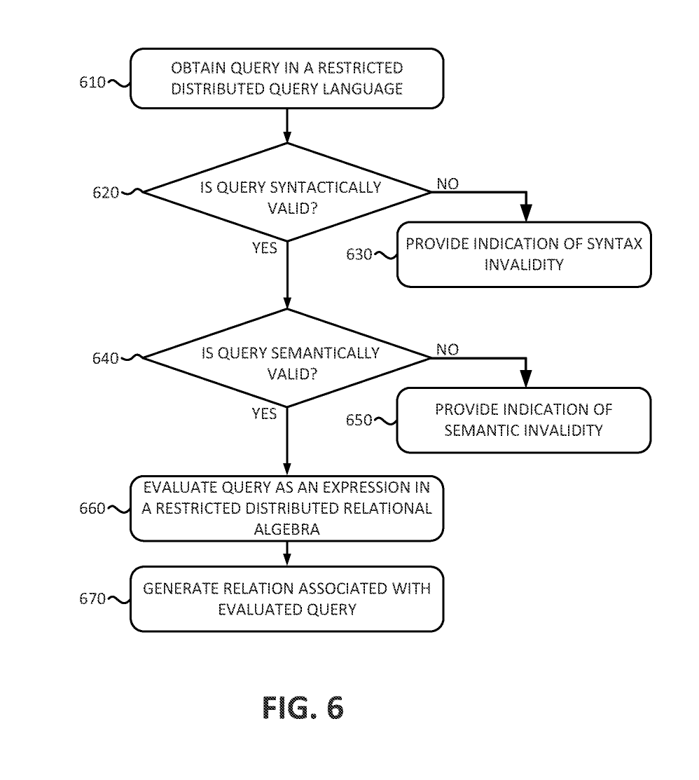

FIG. 6 is a flowchart of an exemplary process for processing a restricted distributed query language according to an implementation described herein. In one implementation, the process of FIG. 6 may be performed by RDRM management system 110. In other implementations, some or all of the process of FIG. 6 may be performed by another device or a group of devices separate from RDRM management system 110 and/or including RDRM management system 110.

The process of FIG. 6 may include obtaining a query in a RDQL (block 610). For example, RDQL processor 310 may detect an RDQL query included in a script or code being processed by RDRM management system 110 or may receive an RDQL query from another computer device with a request to process the RDQL query. The RDQL query may have the following syntax:

| | |
|---|---|
| SELECT | e₁,...,eₙ |
| FROM | R₁.N₁,..., Rₘ.Nₘ |
| WHERE | φ, |

wherein each eᵢ may correspond to an expression, Rᵢ may correspond to a relation schema name, Nᵢ may correspond to a database node name, and φ may correspond to a predicate.

A determination may be made as to whether the query is syntactically valid (block 620). For example, RDQL processor 310 may check the RDQL query for syntactic validity. If it is determined that the query is not syntactically valid (block 620—NO), an indication of syntactic invalidity may be provided (block 630). For example, RDQL processor 310 may output an error message associated with the RDQL query. If it is determined that the query is syntactically valid (block 620—YES), processing may continue to evaluate the query for semantic validity (block 640).

A determination may be made as to whether the query is semantically valid (block 640). For example, RDQL processor 310 may check the RDQL query for semantic validity. For example, RDQL processor 310 may determine whether the RDQL query references a restricted relation schema R in its “FROM” clause, and may determine whether the predicate in the “WHERE” clause is a “restricted predicate,” meaning whether the predicate assigns either a value or an attribute from another relation schema appearing to the left of R in the “FROM” clause for each access key attribute of R. Otherwise, RDQL processor 310 may determine that the RDQL query does not correspond to a semantically valid query.

In more formal terms, the predicate in the “WHERE” clause of an RDQL query corresponds to a restricted predicate if and only if it is logically equivalent to the following predicate:
ψ AND φ(R₁) AND . . . AND φ(Rₘ),

wherein R₁, . . . , Rₘ correspond to the list of relation schema names appearing in the “FROM” clause of the RDQL query from left to right, ψ corresponds to an arbitrary predicate, and φ(R) corresponds to a predicate assigning either a value or an attribute from another relation schema appearing to the left of R in the “FROM” clause to each access key attribute of R, when R corresponds to a restricted relation schema. If R does not correspond to a restricted schema, then φ(R) may be defined as the neutral predicate TRUE.

In simpler terms, the predicate in the “WHERE” clause of an RDQL query may be required to assign values to all attributes in the access key of any restricted relation schema referenced in the “FROM” clause of the RDQL query. These values may be assigned either directly using a constant value or indirectly via an attribute of a predecessor relation schema referenced in the “FROM” clause. Additionally, the predicate may include other arbitrary conditions represented above by predicate ψ.

If it is determined that the query is not semantically valid (block 640—NO), an indication of semantic invalidity may be provided (block 650). For example, RDQL processor 310 may output an error message associated with the RDQL query. If it is determined that the query is semantically valid (block 640—YES), processing may continue to evaluate the query as an expression in RDRA (block 660).

Assume the following semantically valid RDQL query:

| | |
|---|---|
| SELECT | e₁,...,eₙ |
| FROM | R₁.N₁,..., Rₘ.Nₘ |
| WHERE | ψ AND φ(R₁) AND ... AND φ(Rₘ) |

The RDQL query may be evaluated as the following expression in RDRA:

$${π}_{{e}_{1} , … , {e}_{n}} ( {σ}_{ψ} ( Δ ( {R}_{1} \cdot {N}_{1} ) {⊗}_{{ϕ}_{{R}_{2}}} … {⊗}_{{ϕ}_{{R}_{m}}} Δ ( {R}_{m} \cdot {N}_{m} ) ) ) \qquad ( Eq . 1 )$$

In Eq. 1, πₑ_{₁}_{, . . . , e}_{ₙ} may correspond to a projection operation onto expressions e₁, . . . , eₙ, σ_{ψ may} correspond to a selection operation based on predicate ψ, [symbol] _{θ} may correspond to a restricted dependent-join operation using predicate θ, Δ(R.N) may correspond to a function defined as follows:

$$Δ ( R . N ) = \{ \begin{matrix}{σ}_{φ ( R ) / V} ( R . N ) , & if R corresponds to a restricted schema \\ R . N , & if R does not correspond to a restricted relational schema\end{matrix} \} \qquad Eq . ( 2 )$$

and Φ_{R} may correspond to a function defined as follows:

$${Φ}_{R} = \{ \begin{matrix}φ ( R ) / A , & if R corresponds to a restricted relational schema \\ TRUE , & if R does not correspond to a restricted relational schema\end{matrix} \} \qquad Eq . ( 3 )$$

A clause of the form “A=v,” in which “A” corresponds to an attribute and “v” corresponds to a value, may be designated as a value clause. A clause of the form “A=B,” in which “A” corresponds to a first attribute of a first relation schema and wherein “B” corresponds to a second attribute of a second relation schema, may be designated as an attribute clause. For example, if a relation schema “statistics” includes an attribute “timestamp,” a clause “statistics.timestamp=01-01&00-00” may correspond to a value clause. As another example, if the relation schema “statistics” includes an attribute “port_id” and if another relation schema “switch” includes an attribute “port_id,” the clause “switch.port_id=statistics.port_id” may correspond to an attribute clause.

In Eq. (2), “φ(R)/V” may correspond to a restriction of predicate φ(R) to value clauses, that is, a predicate comprised exactly by all value clauses in φ(R), connected using the “AND” operator. In Eq. (3), “φ(R)/A” may correspond to a restriction of predicate φ(R) to attribute clauses, that is, a predicate comprised exactly by all attribute clauses in φ(R), connected using the “AND” operator.

A relation associated with the evaluated query may be generated (block 670). For example, RDRM manager 320 may evaluate the RDRA expression with respect to a relation schema record 400 associated with the RDQL query. Alternatively or additionally, RDRM manager 320 may evaluate the RDRA expression by providing the RDRA expression to abstract request generator 340 and by receiving a table from concrete response translator 380 based on a parsed response. RDRM manager 320 may generate a relation based on the table.

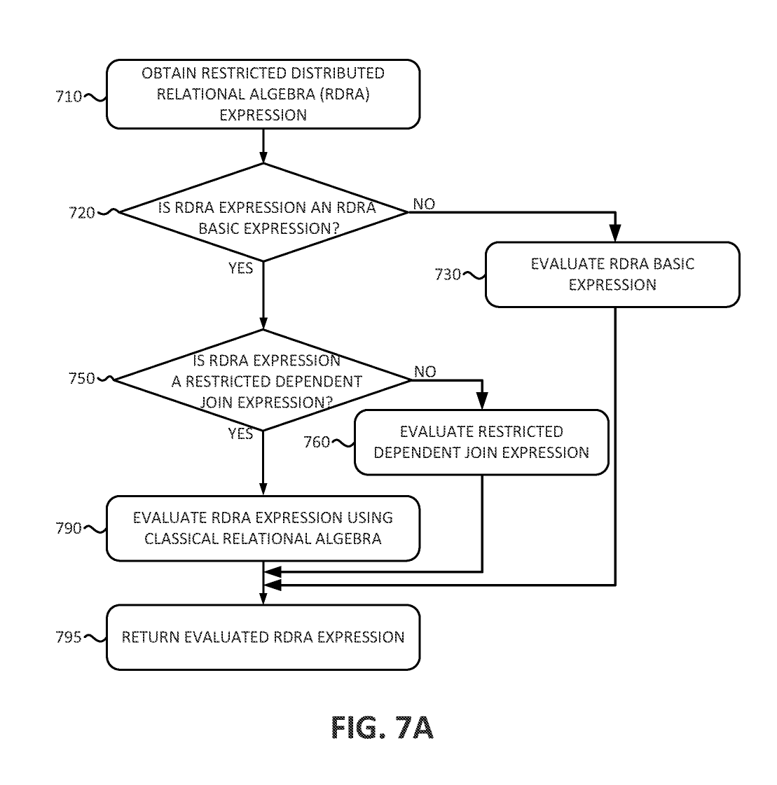

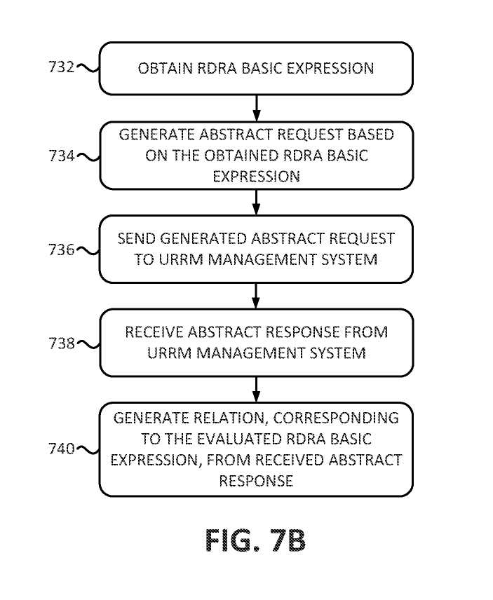

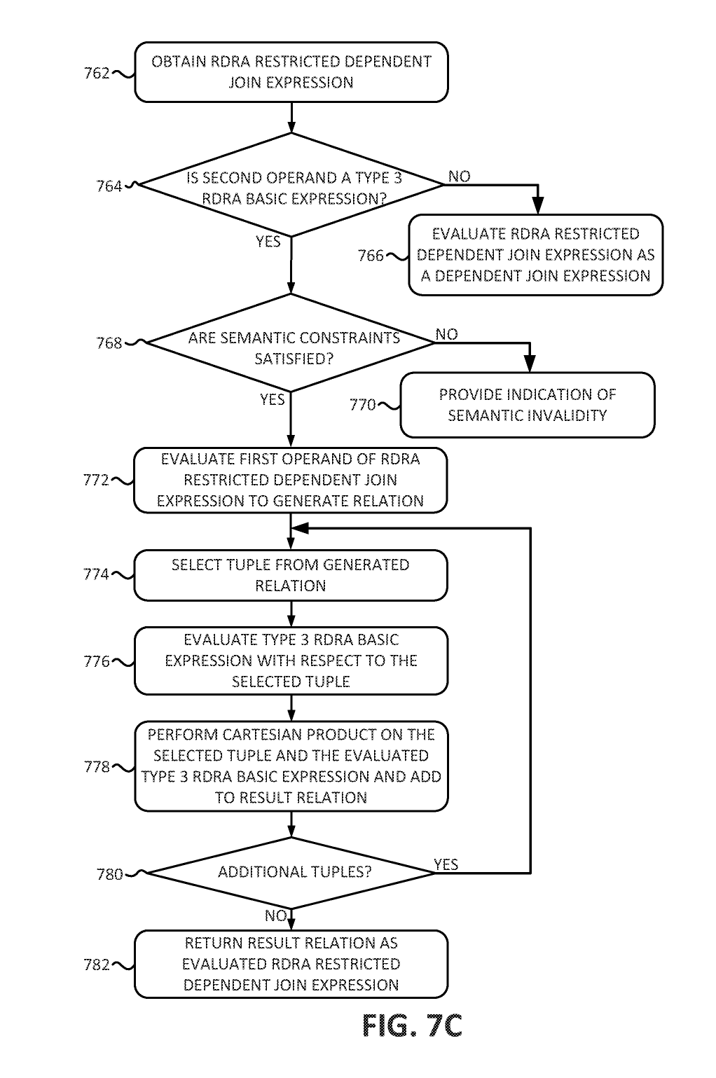

FIGS. 7A-7C are flowcharts of an exemplary process for evaluating an RDRA expression according to an implementation described herein. In one implementation, the process of FIGS. 7A-7C may be performed by RDRM management system 110. In other implementations, some or all of the process of FIGS. 7A-7C may be performed by another device or a group of devices separate from RDRM management system 110 and/or including RDRM management system 110.

The process of FIG. 7A may include obtaining an RDRA expression (block 710). For example, RDRA evaluator 420 may receive an RDRA expression from RDQL processor 310 for evaluation. A determination may be made as to whether the RDRA expression corresponds to a basic expression (block 720). For example, RDRA evaluator 320 may determine whether the obtained RDRA expression corresponds to a type-1 basic expression, a type-2 basic expression, or a type-3 basic expression. RDRA evaluator 320 may access relation schema attribute relation 480 to determine whether a relation schema corresponds to a restricted relation schema.

If it is determined that the RDRA expression corresponds to an RDRA basic expression (block 720—YES), the RDRA basic expression may be evaluated (block 730). A process of evaluating RDRA basic expressions is described below with reference to FIG. 7B. A relation corresponding to the evaluated RDRA basic expression may be obtained and processing may continue to block 795. If it is determined that the RDRA expression does not correspond to an RDRA basic expression (block 720—NO), a determination may be made as to whether the RDRA expression corresponds to a restricted dependent join expression (block 750). For example, RDRA evaluator 320 may determine whether the second expression of the RDRA expression includes a selection from a restricted relation schema, based on the information stored in relation schema attribute relation 480.

If it is determined that the RDRA expression corresponds to a restricted dependent join expression (block 750—YES), the restricted dependent join expression may be evaluated (block 760). A process of evaluating restricted dependent join expressions is described below with reference to FIG. 7C. A relation corresponding to the evaluated restricted dependent join expression may be obtained and processing may continue to block 795. If it is determined that the RDRA expression does not correspond to a restricted dependent join expression (block 750—NO), the RDRA expression may be evaluated using classical relational algebra (block 790). For example, the obtained RDRA expression may consist of classical relational algebra operations involving RDRA basic expressions and/or restricted dependent join expressions. The RDRA basic expressions and/or restricted dependent join expressions may be evaluated to obtain relations and RDRA evaluator 320 may perform one or more projection operations, selection operations, dependent join operations, and/or other types of relational operations on the obtained relations to complete the evaluation of the obtained RDRA expression. The evaluated RDRA expression may be returned (block 795). For example, RDRA evaluator 320 may return a relation corresponding to the evaluated RDRA expression to RDQL processor 310.

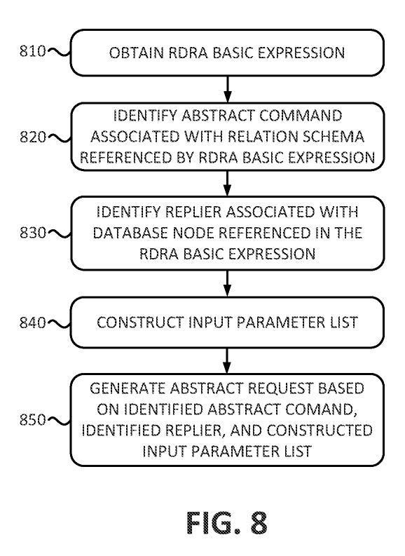

FIG. 7B is a flow chart of a process for evaluating RDRA basic expressions. The process of FIG. 7B may include obtaining an RDRA basic expression (block 732). For example, RDRA evaluator 320 may identify an RDRA basic expression in an RDRA expression received from RDQL processor 310. An abstract request may be generated based on the obtained RDRA basic expression (block 734) and the generated abstract request may be sent to a URRM management system (block 736). For example, RDRA evaluator 320 may call abstract request generator 340 and abstract request generator 340 may generate an abstract request based on the RDRA basic expression. A process of generating an abstract request is described below with reference to FIG. 8. The generated abstract request may be sent to URRM management system 115.

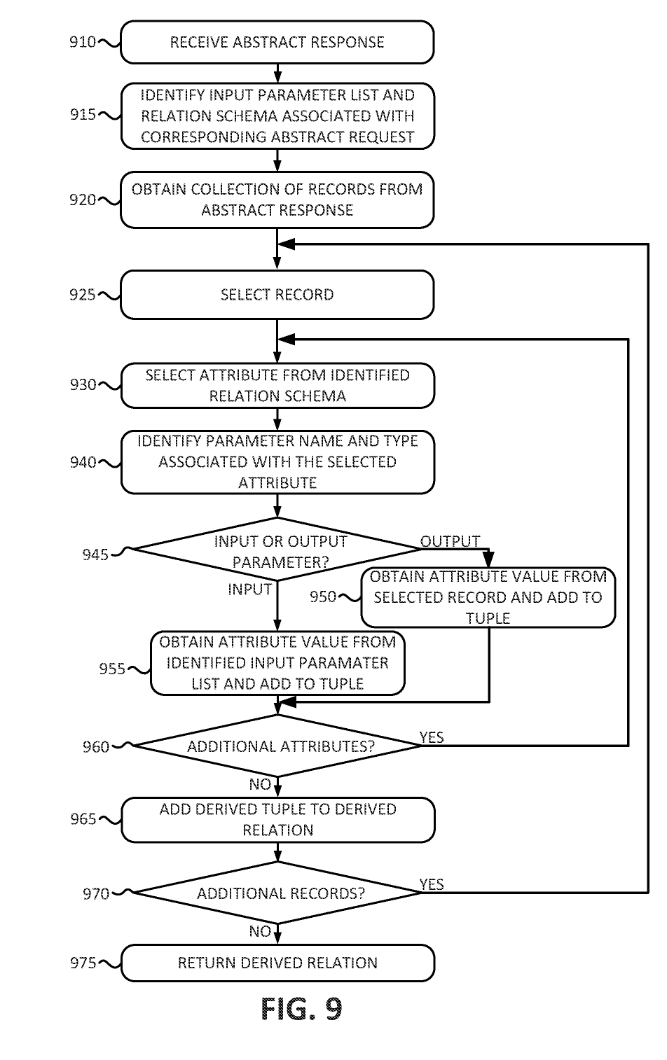

An abstract response may be received from the URRM management system (block 738) and a relation, corresponding to the evaluated RDRA basic expression, may be generated from the received abstract response (block 740). For example, an abstract response, corresponding to the sent abstract request, may be received from URRM management system 115, forwarded to abstract response translator 350, and abstract response translator may derive a relation based on the received abstract response. A process of deriving a relation from an abstract response is described below with reference to FIG. 9. The derived relation may be provided to RDRA evaluator 320 as corresponding to the evaluated RDRA basic expression.

FIG. 7C is a flow chart of a process for evaluating a restricted dependent join expression. The process of FIG. 7C may include obtaining an RDRA restricted dependent join expression (block 762). For example, RDRA evaluator 320 may identify a restricted dependent join expression in an RDRA expression received from RDQL processor 310. A determination may be made as to whether the second operand is a type-3 RDRA basic expression (block 764). For example, RDRA evaluator 320 may access relation schema attribute relation 480 to determine whether the second operand references a restricted relation schema by determining whether access key attribute 486, associated with the relation schema ID attribute 482 of the references relation schema, includes a non-empty access key.

If the second operand is not a type-3 RDRA basic expression (block 764—NO), the RDRA restricted dependent join expression may be evaluated as a dependent join expression (block 766). If the second operand is not a type-3 RDRA basic expression, the RDRA restricted dependent join expression may not involve a restricted relation and thus a classical dependent join expression may be performed. If the second operand is a type-3 RDRA basic expression (block 764—YES), a determination may be made as to whether semantic constraints are satisfied (block 768).

For example, if the second operand in the type-3 RDRA basic expression corresponds to σ_{(φ AND θ)}(R.N), RDRA evaluator 320 may check that predicate φ only includes attributes of relation schema R and that predicate (φ AND θ) corresponds to a correlated access key predicate of R and some correlated access key value with respect to a relation schema referenced by the first operand of the restricted dependent join expression. If the semantic constraints are not satisfied (block 768—NO), an indication of semantic invalidity may be provided (block 770). For example, RDQL processor 310 may output an error message associated with the RDQL query corresponding to the obtained restricted dependent join expression.

If the semantic constraints are satisfied (block 768—YES), the first operand of the RDRA restricted dependent join expression may be evaluated to generate a relation (block 772). For example, the first operand may correspond to an RDRA basic expression or a compound expression that includes one or more relational operations on one or more RDRA basic expressions. Each RDRA basic expression in the first operand may be evaluated (as described above with reference to FIG. 7B) and a relation may be obtained that corresponds to the evaluated RDRA basic expression. If the first operand includes one or more relational operations that are to be performed, the one or more relational operations may be performed on the obtained relation to generate a relation that corresponds to the evaluated first operand.

A tuple may be selected from the generated relation (block 774). For example, the relation generated for the first operand may include one or more tuples. RDRA evaluator 320 may select a tuple from the generated relation. The type-3 RDRA basic expression may be evaluated with respect to the selected tuple (block 776). For example, RDRA evaluator 320 may evaluate the second operand σ_{(φ AND θ)}(R.N) as an RDRA basic expression using attribute values from the selected tuple as the correlated access key values for correlated access key predicate (φ AND θ). A Cartesian product on the selected tuple and the evaluated type-3 RDRA basic expression may be performed and added to a result relation (block 778). For example, RDRA evaluator 320 may perform a Cartesian product between the relation corresponding to the evaluated second operand σ_{(φ AND θ)}(R.N) and the selected tuple to generate a result tuple and may add the result tuple to a result relation. The result relation may start out as an empty relation before the first tuple is selected.

A determination may be made as to whether there are additional tuples (block 780). If there are additional tuples (block 780—YES), processing may return to block 774 to select another tuple. If there are no additional tuples (block 780—NO), the result relation may be returned as the evaluated RDRA restricted dependent join expression (block 782).

The process of FIG. 7C may also be described as follows. Assume an expression of the form E₁ [symbol] _{θ}E₂, where [symbol] _{θ} represents a restricted dependent-join operation using the predicate θ. If E₂ does not correspond to a type-3 expression, E₁ [symbol] _{θ}E₂ may be evaluated as E₁ [symbol] [symbol] _{θ}E₂, where [symbol] [symbol] _{θ} corresponds to a dependent-join operation using predicate θ. However, if E₂ does correspond to a type-3 expression of the form a σ_{φ AND θ}(R.N), E₁ [symbol] _{θ}E₂ may be evaluated by starting with an empty relation result and evaluating expression E₁ as resulting in relation r₁. For each tuple t in r₁, σ_{φ AND θ}(R.N) may be evaluated given the tuple t as the relation temp. A Cartesian product of t and temp may be performed and the resulting relation may be added to result. When evaluating the type-3 expression, additional semantic validity checks may be performed. For example, RDRA evaluator 320 may check to make sure that predicate φ only includes attributes of R and that (φ AND θ) is a correlated access key predicate for R and some correlated access key value with respect to the relation schema of r₁.

FIG. 8 is a flowchart of an exemplary process for generating an abstract request based on a restricted distributed relational algebra expression according to an implementation described herein. In one implementation, the process of FIG. 8 may be performed by RDRM management system 110. In other implementations, some or all of the process of FIG. 8 may be performed by another device or a group of devices separate from RDRM management system 110 and/or including RDRM management system 110.

The process of FIG. 8 may include obtaining an RDRA basic expression (block 810). For example, RDRA evaluator 320 may call abstract request generator 340 to generate an abstract request based on an RDRA basic expression included in an RDRA expression obtained by RDRA evaluator 320 from RDQL processor 310.

An abstract command, associated with a relation schema referenced by the RDRA basic expression, may be identified (block 820). For example, abstract request generator 340 may identify the relation schema associated with the RDRA basic expression by accessing database schema relation 460 to identify the relation schema associated with the database node referenced by the RDRA basic expression. Abstract request generator 340 may then identify the abstract command associated with the identified relation schema by accessing relation schema relation 470.

A replier, associated with the database node referenced in the RDRA basic expression, may be identified (block 830). For example, abstract request generator 340 may identify the replier associated with the database node referenced by the RDRA basic expression by accessing database node relation 450. An input parameter list may be constructed (block 840). For example, abstract request generator 340 may determine the type of the RDRA basic expression. If the RDRA basic expression corresponds to a type-1 RDRA basic expression, the input parameter list may empty. If the RDRA basic expression corresponds to a type-2 RDRA basic expression of the form σ_{φ}(R.N), where predicate <corresponds to (R_attribute_{—}1=value_{—}1 AND R_attribute_{—}2=value_{—}2 AND . . . ), then the input parameter list may be assigned as {input_parameter_{—}1|->value_{—}1, input_parameter_{—}2|->value_{—}2, . . . }, where “p|->v” indicates that v is assigned to p.

If the RDRA basic expression corresponds to a type-3 RDRA basic expression of the form σ_{φ}(R.N), where predicate φ corresponds to (R_attribute_{—}1=expression_{—}1 AND R_attribute_{—}2=expression_{—}2 AND . . . ), a tuple may be obtained for the type-3 RDRA basic expression and predicate φ may be completed using to obtained tuple to yield predicate φ′ corresponding to (R_attribute_{—}1=value_{—}1 AND R_attribute_{—}2=value_{—}2 AND . . . ). The input parameter list may be assigned as {input_parameter_|->value_{—}1, input_parameter_{—}2|->value_{—}2, . . . }.

An abstract request may be generated based on the identified abstract command, the identified replier, and the constructed input parameter list (block 850). For example, abstract request generator 340 may generate an abstract request that identifies the identified replier and that includes the constructed input parameter list. The abstract request may be sent to URRM management system 115.

FIG. 9 is a flowchart of an exemplary process for generating a relation based on an abstract response according to an implementation described herein. In one implementation, the process of FIG. 9 may be performed by RDRM management system 110. In other implementations, some or all of the process of FIG. 9 may be performed by another device or a group of devices separate from RDRM management system 110 and/or including RDRM management system 110.

The process of FIG. 9 may include receiving an abstract response (block 910). For example, RDRM management system 110 may receive an abstract response from URRM management system 115 and forward the abstract response to abstract response translator 350 for processing. An input parameter list and relation schema associated with a corresponding abstract request may be identified (block 915). For example, abstract response translator 350 may determine replier 130 identified in the received abstract response, may identify the abstract request that was sent to the identified replier 130, and may identify the input parameter list and relation schema associated with the identified abstract request.

A collection of records may be obtained from the abstract response (block 920) and a record may be selected from the collection of records (block 925). For example, abstract response translator 350 may retrieve the collection of records included in the abstract response and select one of the records. An attribute may be selected from the identified relation schema (block 930). For example, abstract response translator 350 may select an attribute in relation schema attribute relation 480 for which the relation schema ID attribute 482 corresponds to the identified relation schema associated with replier 130 associated with the abstract response.

A parameter name and type, associated with the selected attribute, may be identified (block 940) and a determination may be made as to whether the parameter corresponds to an input parameter or an output parameter (block 945). For example, abstract response translator 350 may identify the parameter associated with the selected attribute based on abstract command parameter name attribute 488 and may determine whether the parameter corresponds to an input parameter or an output parameter based on abstract command parameter type attribute 490.

If the parameter corresponds to an output parameter (block 945—OUTPUT), an attribute value may be obtained from the selected record and added to a tuple (block 950). For example, abstract response translator 350 may assign an attribute value to the selected attribute from the selected record from the collection of records included in the received abstract response. The attribute value may be assigned to the selected attribute and added to a tuple derived for the selected record. If the parameter corresponds to an input parameter (block 945—INPUT), an attribute value may be obtained from the identified input parameter list and added to a tuple (block 955). For example, abstract response translator 350 may assign an attribute value to the selected attribute from the value assigned to the parameter in the generated input parameter list from the corresponding abstract request. The attribute value may be assigned to the selected attribute and added to a tuple derived for the selected record.

A determination may be made as to whether there are additional attributes in the derived tuple (block 960). For example, abstract response translator 350 may determine whether there are additional attributes in relation schema attribute relation 480 for which the relation schema ID attribute 482 corresponds to the identified relation schema associated with replier 130 associated with the abstract response. If there are additional attributes (block 960—YES), processing may return to block 935 to select another attribute from the derived tuple. If there are no additional attributes (block 960—NO), the derived tuple may be added to a derived relation (block 965). For example, abstract response translator 350 may generate a derived relation that corresponds to an evaluated RDRA basic expression corresponding to the abstract response and may add the derived tuple, associated with the selected record, to the derived relation.

A determination may be made as to whether there are additional records in the collection of records (block 970). For example, abstract response translator 350 may determine whether additional records in the received abstract response need to be processed. If there are additional records (block 970—YES), processing may return to block 925 to select another record from the collection of records. If there are no additional records (block 970—NO), the derived relation may be returned (block 975). For example, abstract response translator 350 may provide the derived relation to RDRA evaluator 320 as corresponding to an evaluated RDRA basic expression.

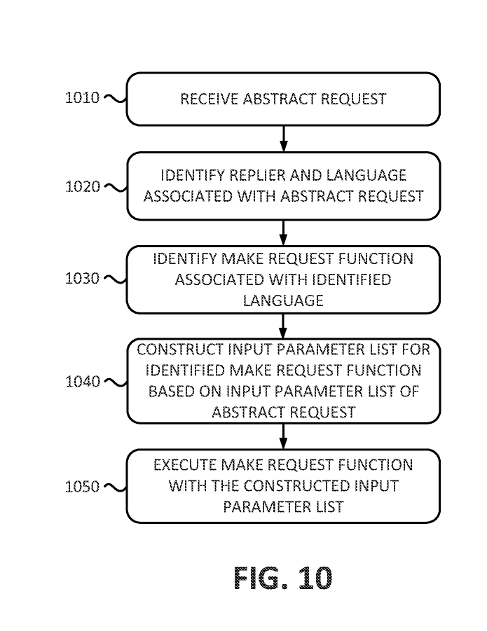

FIG. 10 is a flowchart of an exemplary process for generating a concrete request based on an abstract request according to an implementation described herein. In one implementation, the process of FIG. 10 may be performed by URRM management system 115. In other implementations, some or all of the process of FIG. 10 may be performed by another device or a group of devices separate from URRM management system 115 and/or including URRM management system 115.

The process of FIG. 10 may include receiving an abstract request (block 1010). For example, URRM management system 115 may receive an abstract request from RDRM management system 110 and may forward the received abstract request to concrete request generator 370. A replier and language associated with the abstract request may be identified (block 1020). For example, concrete request generator 370 may retrieve the replier ID from the received abstract request and may access replier relation 410 to determine the R/R language associated with the identified replier.

A make request function associated with the identified language may be identified (block 1030) and an input parameter list for the identified make request function may be constructed based on the input parameter list of the abstract request (block 1040). For example, concrete request generator 370 may access language relation 430 and determine the make request function associated with the identified language and may construct an input parameter list for the make request function by associating each parameter in the input parameter list from the received abstract request with a parameter associated with the make request function. The make request function may be executed with the constructed parameter list (block 1050). For example, concrete request generator 370 may execute the make request function to generate a concrete request in the identified R/R language and may send the concrete request to replier 130. For example, a TL1 command may be sent to a network element that uses the TL1 language.

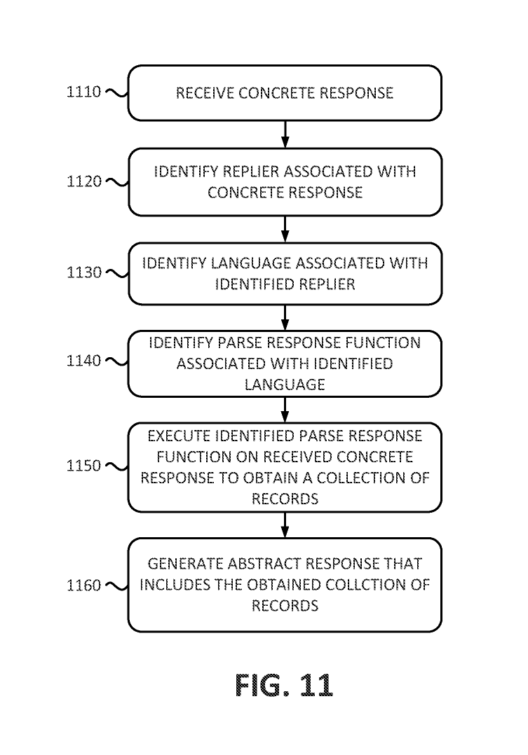

FIG. 11 is a flowchart of an exemplary process for generating an abstract response based on a concrete response according to an implementation described herein. In one implementation, the process of FIG. 11 may be performed by URRM management system 115. In other implementations, some or all of the process of FIG. 11 may be performed by another device or a group of devices separate from URRM management system 115 and/or including URRM management system 115.

The process of FIG. 11 may include receiving a concrete response (block 1110). For example, URRM management system 115 may receive a concrete response in a particular R/R language from replier 130. As an example, URRM management system 115 may receive a TL1 response from replier 130 that uses TL1 language. A replier associated with the concrete response may be identified (block 1120) and a language associated with the identified replier may be identified (block 1130). For example, concrete response translator 380 may identify replier 130 based on information included in the received concrete response and based on information included in replier specific information attribute 418 of replier relation 410. Concrete response translator 380 may then identify the R/R language associated with the identified replier based on information included in language ID attribute 414 of replier relation 410.

A parse response function associated with the identified language may be identified (block 1140) and the identified parse response function may be executed on the received concrete response to obtain a collection of records (block 1150). For example, concrete response translator 380 may identify the parse response function associated with the identified R/R language by accessing language relation 430 and may execute the identified parse response function to generate a collection of records. The parse response function may need to access the concrete command specifications (e.g., command syntax) stored in concrete command specifications attribute 446 of concrete command relation 440 in order to be able to parse a concrete response in the particular R/R language. An abstract response may be generated that includes the obtained collection of records (block 1160). For example, concrete response translator 380 may generate an abstract response that includes the obtained collection of records and send the abstract response to RDRM management system 110.

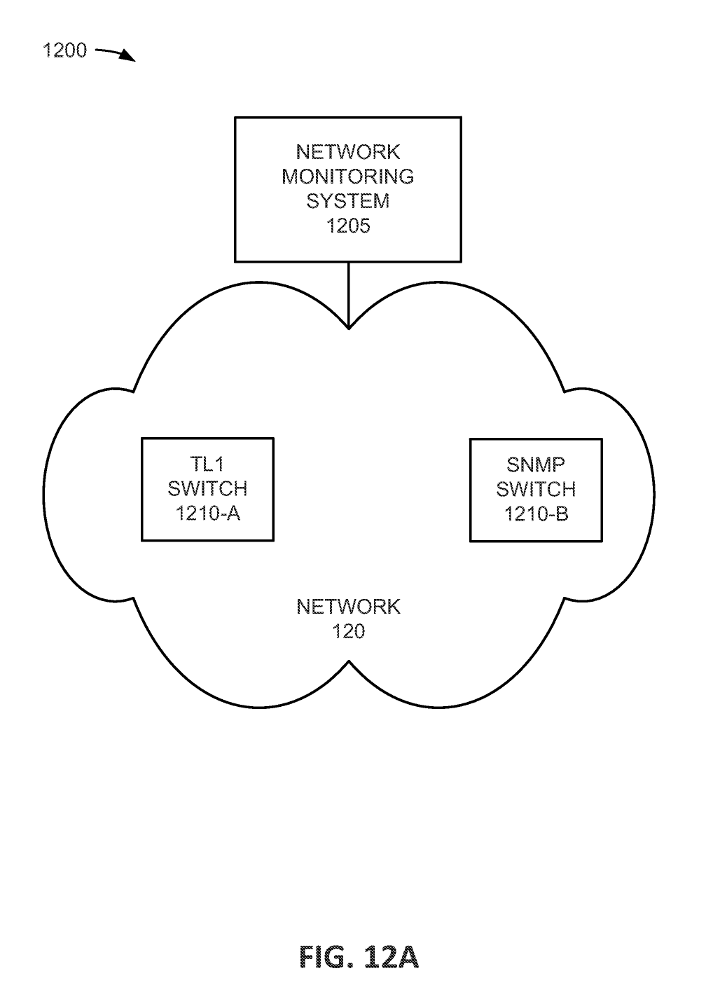

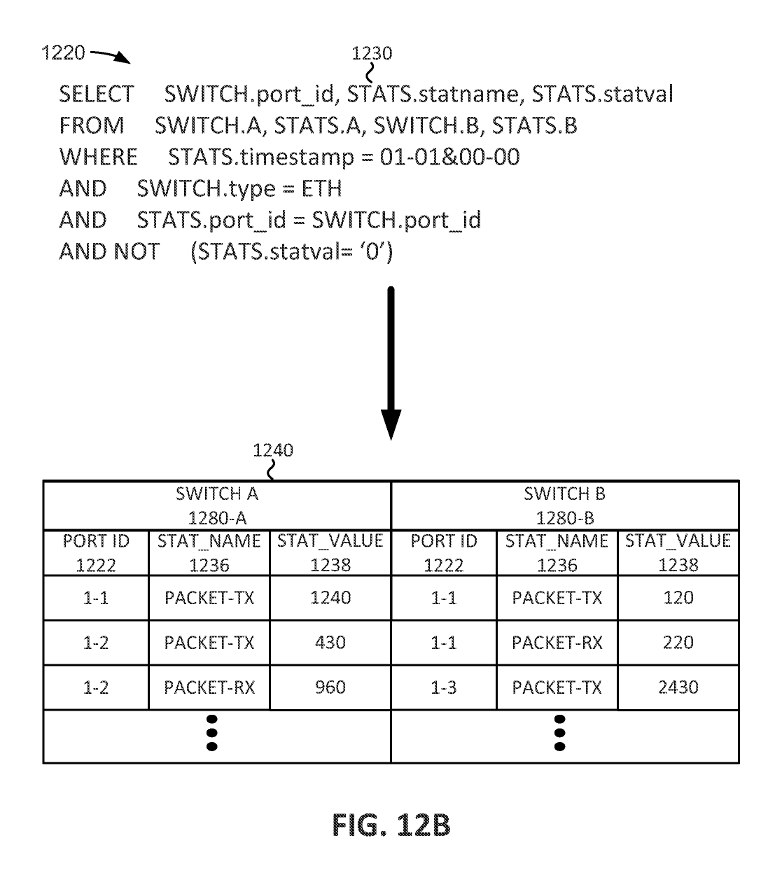

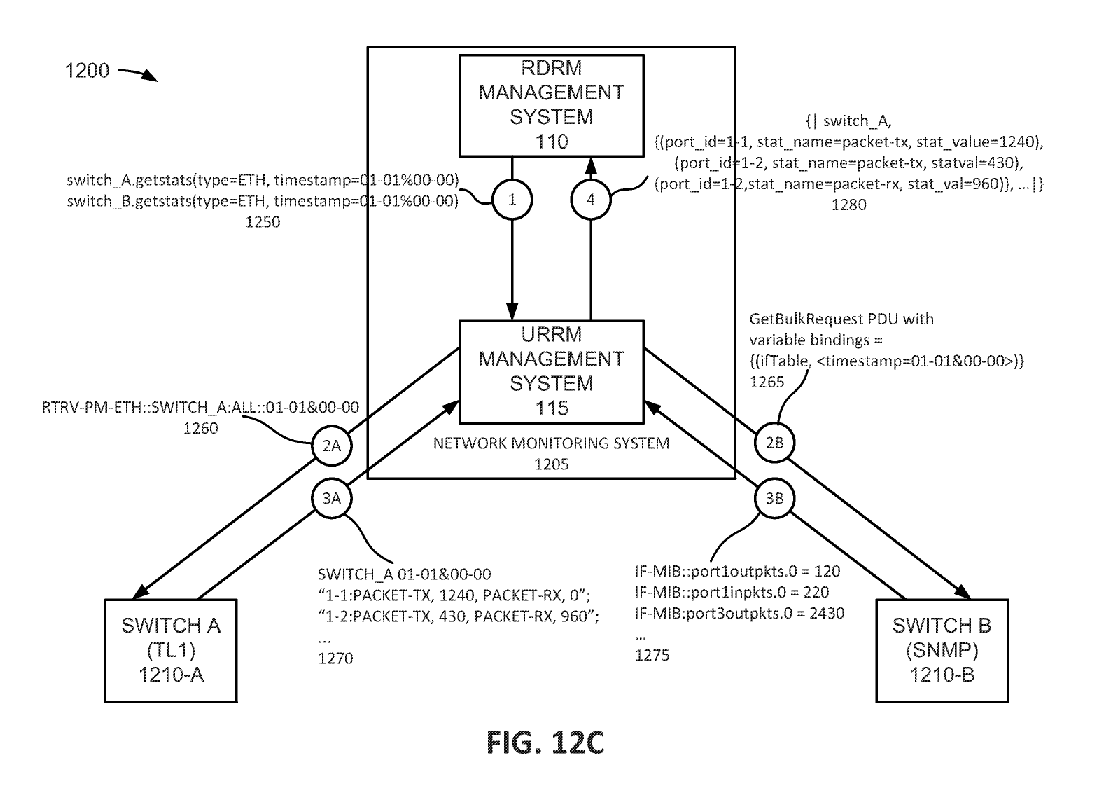

FIGS. 12A-12C are diagrams of a first example that illustrates a relational approach to network monitoring according to an implementation described herein. FIG. 12A illustrates a system 1200 that includes a network monitoring system 1205, network 120, and switches 1210-A and 1210-B. Switch 1210-A may be configured to use TL1 language and switch 1210-B may be configured to use SNMP. While only two switches are shown in FIG. 12A for illustrative purposes, in practice, system 1200 may include a large number of switches or other types of network elements.

In system 1200, network monitoring system 1205 may correspond to RDRM management system 110 and URRM management system 115, and switches 1210-A and 1210-B may correspond to repliers 130. Network monitoring system 1205 may monitor switches 1210-A and 1210-B using RDQL queries. Thus, switches 1210-A and 1210-B may be interpreted by network monitoring system 1205 as corresponding to a database node of an RDRM.

FIG. 12B illustrates a process 1220 of evaluating a query 1230 into a relation 1240. From the point of view of network monitoring system 1205, query 1230 is evaluated into relation 1240 as if the database nodes and relation schema referenced by query 1230 corresponded to a relational database without any knowledge of an underlying R/R system. Query 1230 may correspond to a request for all non-zero statistics from switch 1210-A and switch 1210-B for timestamp value “01-01 &00-00.” In query 1230, the predicate “STATS.timestamp=01-01 &00-00” may correspond to an access key predicate, and the predicate “STATS.port_id=SWITCH.port_id” may correspond to a correlated access key predicate.

Relation schema STATS may correspond to a restricted relation and may therefore include a non-empty access key. The access key may include the “timestamp” attribute and the “port_id” attribute. Thus, an RDQL query that accesses a relation over relation schema STATS may be required to specify a particular time stamp value and a particular port ID value.

FIG. 12C illustrates the evaluating of query 1230 into relation 1240 using the underlying unified R/R system. FIG. 12C shows that RDRM management system 110 and URRM management system 115 are in this example both implemented within network monitoring system 1205. Process 1220 may begin with RDRA evaluator 320 generating basic expressions based on query 1230 and abstract request generator 340 generating abstract commands 1250 in a common R/R language based on the generated basic expressions. In this case, an RDRA expression corresponding to query 1230 includes two RDRA basic expressions, since the FROM clause of query 1230 references two different database nodes. Abstract commands 1250 may be send to URRM management system 115 (signal flow 1).

URRM management system 115 may receive abstract command 1250 and may generate concrete commands 1260 and 1265 based on the languages associated with switch 1210-A and switch 1210-B. Concrete command 1260 may correspond to a TL1 RTRV-PM-ETH command (signal flow 2A) and concrete command 1265 may correspond to an SNMP GetBulkRequest Protocol Data Unit (PDU) (signal flow 2B). Switch 1210-A may respond with a TL1 response 1270 (signal flow 3A), which may include the statistics associated with switch 1210-A for the timestamp value of 01-01&00-00. Switch 1210-B may response with an SNMP response 1275 (signal flow 3B), which may include the statistics associated with switch 1210-B for the timestamp value of 01-01&00-00.

URRM management system 115 may receive TL1 response 1270 and may parse TL1 response 1270 into a collection of records based on a parse function associated with a TL1 response to a TL1 RTRV-PM-ETH request command. The collection of records may be included in a first abstract response 1280 (signal flow 4) that is send to requestor 105. Similarly, URRM management system 115 may also receive SNMP response 1275 and may parse SNMP response 1275 into a collection of records based on a parse function associated with an SNMP response based on an SNMP GetBulkRequest request command. The collection of records may be included in a second abstract response 1280 (signal flow 4) that is send to requestor 105. RDRA evaluator 320 may receive the abstract responses 1280 and may generate relation 1240 based on the collection of records included in each of the abstract responses 1280.

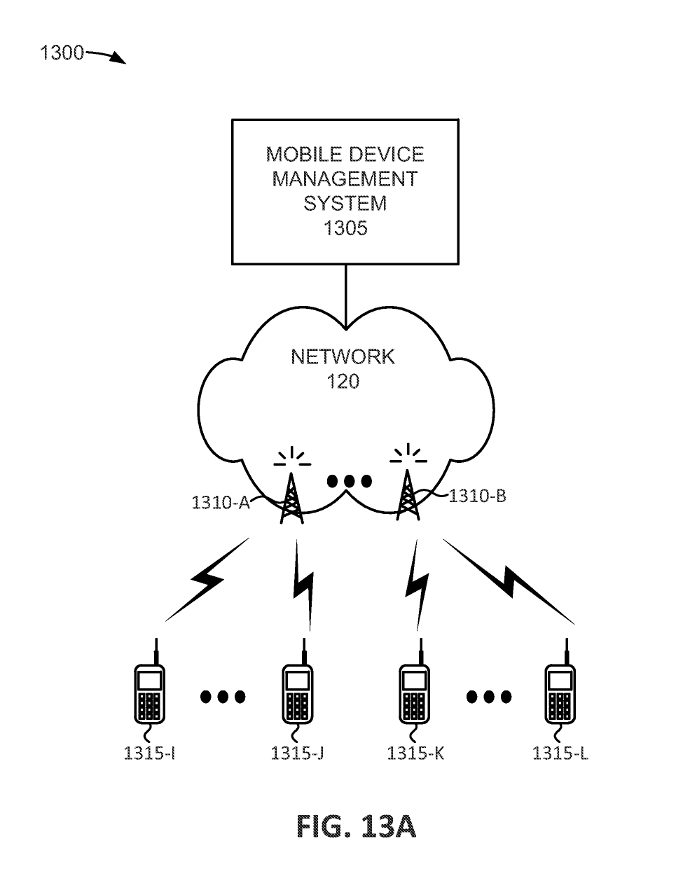

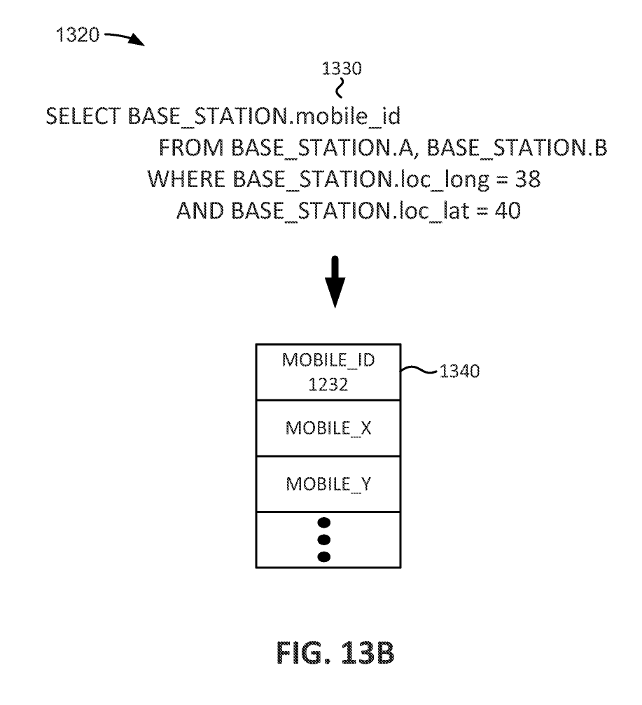

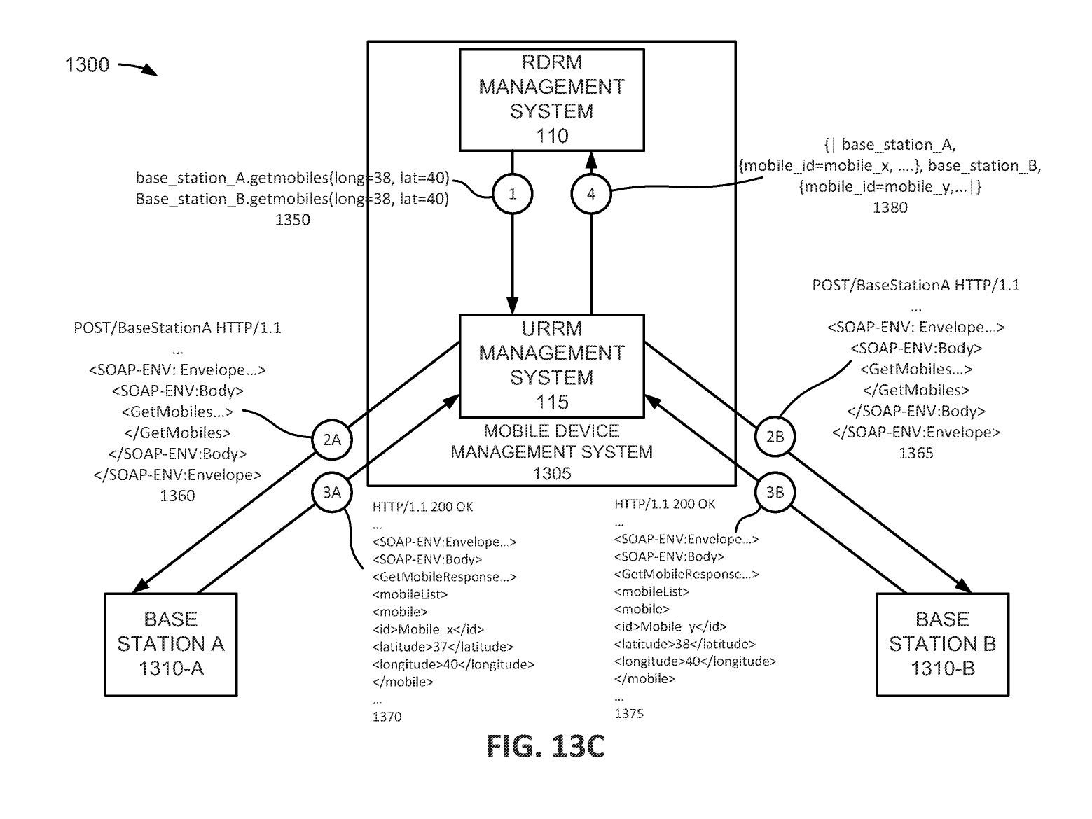

FIGS. 13A-13C are diagrams of a second example that illustrates a relational approach to obtaining mobile device information based on location according to an implementation described herein. FIG. 13A illustrates a system 1300 that includes a mobile device management system 1305, network 120, base stations 1310-A and 1310-B, and mobile devices 1315-I through 1315-J, associated with base station 1310-A and mobile devices 1315-K through 1315-L, associated with base station 1310-B. In system 1300, mobile device management system 1305 may correspond to RDRM management system 110 and URRM management system 115, and base stations 1310 may correspond to repliers 130. Mobile devices 1315 may correspond to mobile communication devices, such as cell phones, associated with subscribers of mobile device management system 1305. Base station 1310 may communicate with mobile devices 1315 via wireless signals and may enable mobile devices 1315 to connect to network 120. Mobile device management system 1305 may monitor and/or manage base stations 1310 using RDQL queries. For example, base stations 1310 may be treated by mobile device management system 1305 as RDRM database nodes.

FIG. 13B illustrates a process 1320 of evaluating a query 1330 into a relation 1340. From the point of view of network monitoring system 1105, query 1330 is evaluated into relation 1340 as if the database nodes and relation schema referenced by query 1330 corresponded to concrete relational database without any knowledge of an underlying R/R system. Query 1330 may correspond to a request for all mobile devices with a location that include a longitude value of “38” and a latitude value of “40.” Relation schema BASE_STATION may correspond to a restricted relation and may therefore include a non-empty access key. The access key may include the “loc_long” attribute and the “loc_lat” attribute.

FIG. 13C illustrates the evaluating of query 1330 into relation 1340 using the underlying unified R/R system. FIG. 13C shows that requestor 105 and URRM management system 115 are in this example both implemented within mobile device management system 1305. Process 1320 may begin with RDRA evaluator 320 generating RDRA basic expressions from query 1330 and abstract request generator 340 generating abstract commands 1350 in a common R/R language based on the generated basic expressions. Abstract commands 1350 may be send to URRM management system 115 (signal flow 1).

Mobile device management system 1305 may communicate with base stations 1310 using Web Services Description Language (WSDL) operation specifications for Web Services. In this example, base stations 1310 may use the same R/R language. Thus, URRM management system 115 may generate a WSDL request command 1360 for location of mobile devices associated with base station 1310-A and may send WSDL request command 1360 to base station 1310-A (signal flow 2A). Base station 1310-A may respond with a WSDL message 1370 (signal flow 3A). Similarly, URRM management system 115 may generate a WSDL request command 1365 for location of mobile devices associated with base station 1310-B, may send WSDL request command 1365 to base station 1310-B (signal flow 2B), and base station 1310-B may respond with a WSDL message 1375 (signal flow 3B).

URRM management system 115 may receive WSDL response 1370 and may parse WSDL response 1370 into a collection of records based on a parse function associated with the WSDL response. The collection of records may be included in a first abstract response 1380 (signal flow 4) that is send to requestor 105. Similarly, URRM management system 115 may also receive WSDL response 1375 and may parse WSDL response 1375 into a collection of records based on the parse function. The collection of records may be included in a second abstract response 1380 (signal flow 4) that is send to requestor 105. RDRA evaluator 320 may receive the abstract responses 1380 and may generate relation 1340 based on the collection of records included in each of the abstract responses 1380.

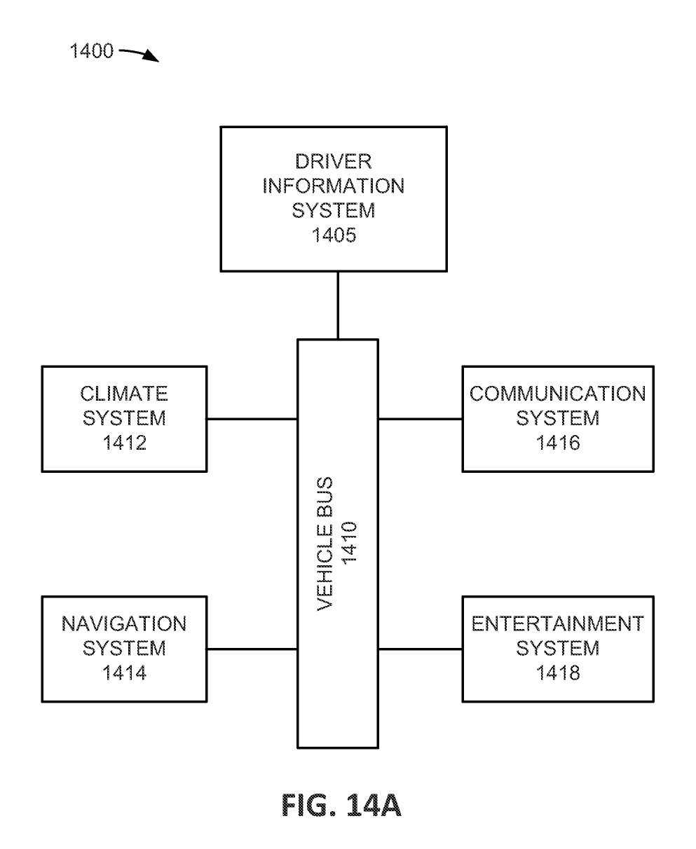

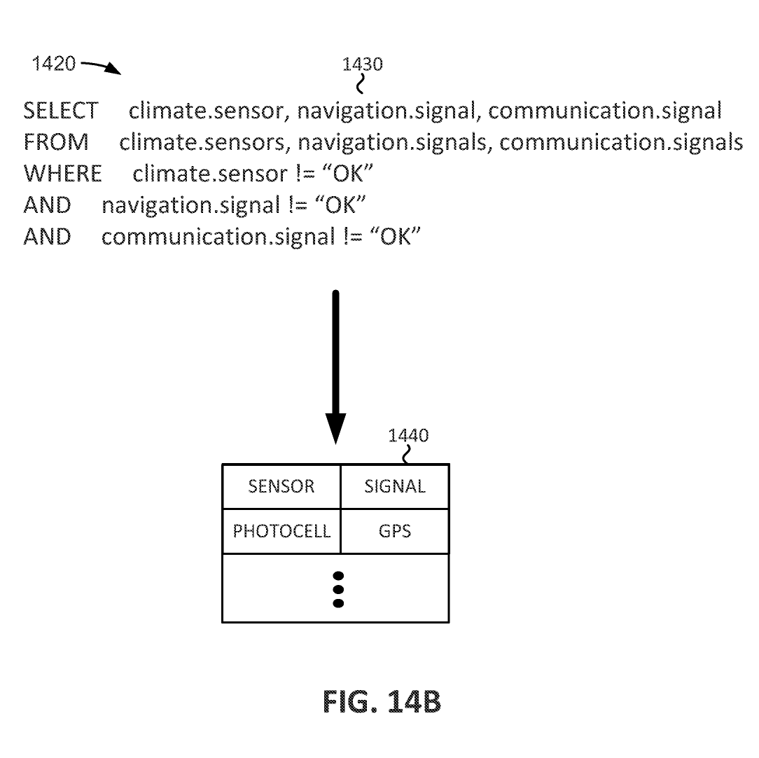

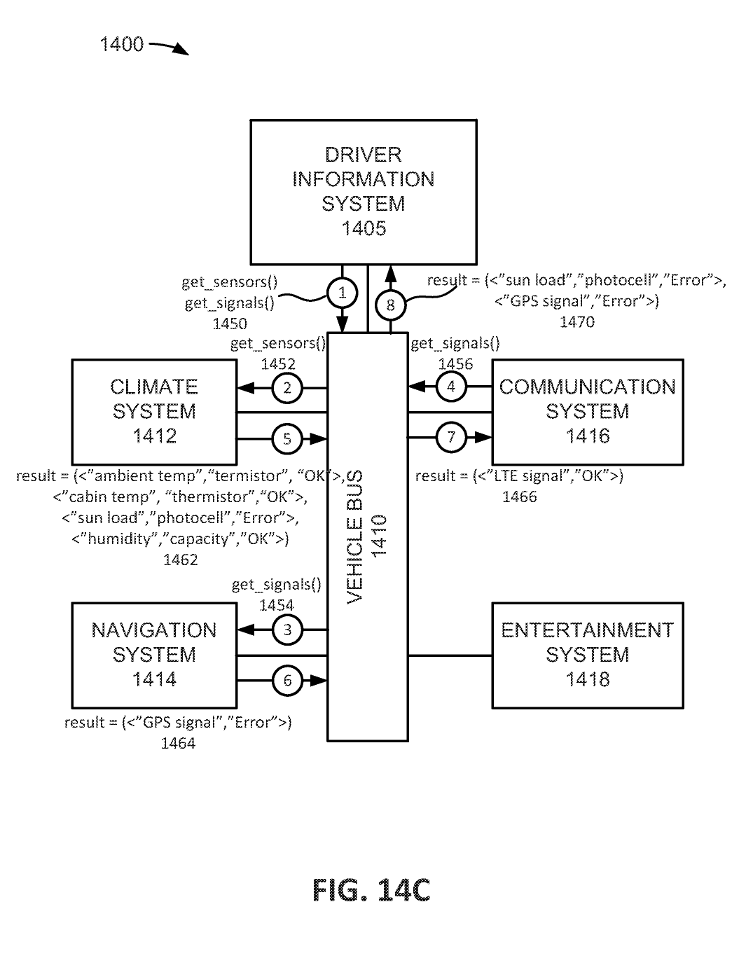

FIGS. 14A-14C are diagrams of a third example that illustrates a relational approach to obtain information from components of a driver information system according to an implementation described herein. FIG. 14A illustrates a vehicle computer system 1400 that includes a driver information system 1405, a vehicle bus 1410, a climate system 1412, a navigation system 1414, a communication system 1416, and an entertainment system 1418.

Driver information system 1405 may monitor the systems in the vehicle, may enable the driver to interact with the various systems, and may inform the driver about the status of the various systems in the vehicle. Vehicle bus 1410 may enable communication between driver information system 1405 and climate system 1412, navigation system 1414, communication system 1416, and entertainment system 1418. Climate system 1412 may control the climate of the vehicle and may include sensors, such as an ambient temperature sensor, a cabin temperature sensor, a sun load sensor, and a humidity sensor. Navigation system 1414 may include a Global Positioning System (GPS) receiver and may determine a location of the vehicle using the GPS receiver. Communication system 1416 may include a wireless transmitter that may enable the user send or receive wireless messages or telephone calls. Entertainment system 1418 may include a media player, such as a satellite radio, an MP3 player, or a DVD player.

In vehicle computer system 1400, driver information system 1405 may correspond to RDRM management system 110 and URRM management system 115, and driver information system 1405 and climate system 1412, navigation system 1414, communication system 1416, and entertainment system 1418 correspond to repliers 130. Driver information system 1405 may climate system 1412, navigation system 1414, communication system 1416, and entertainment system 1418 using RDQL queries. Thus, climate system 1412, navigation system 1414, communication system 1416, and entertainment system 1418 may be interpreted by driver information system 1405 as corresponding to a database node of an RDRM.

FIG. 14B illustrates a process 1420 of evaluating a query 1430 into a relation 1440. From the point of view of driver information system 1405, query 1430 is evaluated into relation 1440 as if the database nodes and relation schema referenced by query 1430 corresponded to concrete relational database without any knowledge of an underlying R/R system. Query 1430 may correspond to a request for all sensors and signals that are not reporting an OK signal.

FIG. 14C illustrates the evaluating of query 1230 into relation 1440 using the underlying unified R/R system. Driver information system 1405 and climate system 1412, navigation system 1414, communication system 1416, and entertainment system 1418 may be part of a Common Object Request Broker Architecture (CORBA) software environment. A CORBA environment may enable software components written in different computer languages and running on different computer platform to communicate with each other using Interface Definition Language (IDL).

Process 1420 may begin with driver information system 1405 generating basic expressions from query 1430 and generating commands 1450 in a common R/R language based on the generated basic expressions. For example, an IDL get_sensors( ) command 1452 may be sent to climate system 1412 (signal flow 2), an IDL get_signals( ) command 1454 may be sent to navigation system 1414 (signal flow 3), and an IDL a get_signals( ) command 1456 may be sent to communication system 1416 (signal flow 4.)

Climate system 1412 may respond with an IDL result response 1462 (signal flow 5), navigation system 1414 may respond with an IDL result response 1464 (signal flow 6), and communication system 1416 may response with an IDL response 1466 (signal flow 7). Vehicle bus 1410 may generate an IDL result response 1470 and provide the IDL result response 1470 to driver information system 1405 (signal flow 8). Driver information system 1405 may generate relation 1440 based on the received IDL response 1470.

In yet another example, systems and methods described herein may be used in connection with another application. As an example, systems and methods described herein may be used in connection with a geographic information system (GIS) to obtain geographic data from elements associated with the GIS. For example, RDQL queries may be used to obtain information about features associated with a particular set of geographic coordinates.

As another example, systems and methods described herein may be used in connection with geometric applications in which spatial data is manipulated. For example, a geometric shape may be represented as a relation with an x-coordinate attribute and a y-coordinate attribute and tuples that identify all the coordinates that are included in the shape. As another example, a geographic region may be expressed as a relation that includes tuples identifying all sets of coordinates included within the geographic region.

As yet another example, systems and methods described herein may be used to manage information about trajectories of elements, wherein a trajectory of an element is represented as a relation, in which each tuple identifies a particular location at a particular point in time. As yet another example, systems and methods described herein may be used to manage information about a set of sensors, in which each sensor records data about one or more attributes. A relation associated with a sensor may include tuples, wherein each tuple records one or more attributes at a particular point in time.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with respect to FIGS. 5-11, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method performed by a computer device, the method comprising:
identifying, by the computer device, a query in a query language;
converting, by the computer device, the identified query into one or more request commands, each of the one or more request commands being in a particular request and response language;
sending, by the computer device, the one or more request commands to one or more repliers, wherein the one or more repliers are referenced by the identified query;
receiving, by the computer device, one or more responses from the one or more repliers, each of the one or more responses being in a particular request and response language; and
converting, by the computer device, the received one or more responses into a relation in the query language, wherein the relation corresponds to an evaluation of the query.

2. The method of claim 1, wherein converting the identified query into one or more request commands includes:
identifying a replier, of the one or more repliers, referenced by the query;
identifying a request and response language associated with identified replier,
determining one or more input parameters associated with a request command in the identified request and response language;
determining values for the one or more input parameters based on the query; and
generating the request command in the identified request and response language using the determined values for the one or more input parameters.

3. The method of claim 2, wherein at least one of the one or more input parameters corresponds to a temporal or spatial parameter and wherein at least one of the one or more values includes a temporal or spatial value.

4. The method of claim 1, wherein converting the received one or more responses into a relation in the restricted distributed query language includes:
identifying a replier, of the one or more repliers, associated with a particular one of the received one or more responses;
identifying a request and response language associated with identified replier,
selecting a parse function associated with the identified request and response language;
parsing the particular one of the received one or more responses using the selected parse function into a collection of records; and
generating the relation based on the collection of records.

5. The method of claim 1, further comprising:
determining whether the query corresponds to a semantically valid query; and
providing an indication that the query does not correspond to a semantically valid query, when the query does not correspond to a semantically valid query.

6. The method of claim 5, wherein determining whether the query corresponds to a semantically valid query includes:
determining whether a predicate associated with the query references a restricted relation;
determining whether the predicate assigns a value to each access key attribute associated with the restricted relation, when the predicate associated with the query references a restricted relation; and
determining that the query does not correspond to a semantically valid query, when the predicate does not assign a value to each access key attribute associated with the restricted relation.

7. The method of claim 1, wherein the request and response language corresponds to a network monitoring language and wherein the one or more repliers include a switch, a router, a firewall, or a wireless access point.

8. The method of claim 7, wherein the network monitoring language corresponds to Transactional Language One or Simple Network Management Protocol.

9. The method of claim 1, wherein the request and response language corresponds to a mobile communication device monitoring language and wherein the one or more repliers include a mobile communication device.

10. The method of claim 1, wherein the request and response language corresponds to a specification language and wherein the one or more repliers include a programming object.

11. The method of claim 1, further comprising:
identifying one or more database nodes associated with a relation schema;
associating a particular one of the one or more database nodes with a particular one of the one or more repliers;
identifying one or more input parameters associated with the one or more repliers;
generating an access key for the relation schema based on the identified one or more input parameters; and
using the generated access key to determine whether the query corresponds to a valid query associated with the relation schema.

12. A computing device comprising:
logic configured to:
identify a query in a query language;
convert the identified query into one or more request commands, each of the one or more request commands being in a particular request and response language;
send the one or more request commands to one or more repliers, wherein the one or more repliers are referenced by the identified query;
receive one or more responses from the one or more repliers, each of the one or more responses being in a particular request and response language; and
convert the received one or more responses into a relation in the query language, wherein the relation corresponds to an evaluation of the query.

13. The computing device of claim 12, wherein the logic is further configured to:
identify a replier, of the one or more repliers, referenced by the query;
identify a request and response language associated with identified replier;
determine one or more input parameters associated with a request command in the identified request and response language;
determine values for the one or more input parameters based on the query; and
generate the request command in the identified request and response language using the determined values for the one or more input parameters.

14. The computing device of claim 12, wherein the at least one of the one or more input parameters corresponds to a temporal or spatial parameter and wherein at least one of the one or more values includes a temporal or spatial value.

15. The computing device of claim 12, wherein the logic is further configured to:
identify a replier, of the one or more repliers, associated with a particular one of the received one or more responses;
identify a request and response language associated with identified replier;
select a parse function associated with the identified request and response language;
parse the particular one of the received one or more responses using the selected parse function into a collection of records; and
generate the relation based on the collection of records.

16. The computing device of claim 12, wherein the request and response language corresponds to a network monitoring language and wherein the one or more repliers include a switch, a router, a firewall, or a wireless access point.

17. The computing device of claim 16, wherein the network monitoring language corresponds to Transactional Language One or Simple Network Management Protocol.

18. A non-transitory computer-readable medium, storing instructions executable by one or more processors, the non-transitory computer-readable medium comprising:
one or more instructions to identify a query in a query language;
one or more instructions to convert the identified query into one or more request commands, each of the one or more request commands being in a particular request and response language;
one or more instructions to send the one or more request commands to one or more repliers, wherein the one or more repliers are referenced by the identified query;
one or more instructions to receive one or more responses from the one or more repliers, each of the one or more responses being in a particular request and response language; and
one or more instructions to convert the received one or more responses into a relation in the query language, wherein the relation corresponds to an evaluation of the query.

19. The non-transitory computer-readable medium of claim 18, wherein the one or more instructions to convert the identified query into one or more request commands include:
one or more instructions to identify a replier, of the one or more repliers, referenced by the query;
one or more instructions to identify a request and response language associated with identified replier;
one or more instructions to determine one or more input parameters associated with a request command in the identified request and response language;
one or more instructions to determine values for the one or more input parameters based on the query; and
one or more instructions to generate the request command in the identified request and response language using the determined values for the one or more input parameters.

20. The non-transitory computer-readable medium of claim 18, wherein the one or more instructions to convert the received one or more responses into a relation in the restricted distributed query language include:
one or more instructions to identify a replier, of the one or more repliers, associated with a particular one of the received one or more responses;
one or more instructions to identify a request and response language associated with identified replier;
one or more instructions to select a parse function associated with the identified request and response language;
one or more instructions to parse the particular one of the received one or more responses using the selected parse function into a collection of records; and
one or more instructions to generate the relation based on the collection of records.
